(19) United States
(12) Patent Application Publication
(10) Pub. No.: US 2007/0099683 A1
(43) Pub. Date: May 3, 2007

(54) Interactive pictures

(75) Inventors: Philip Thunder Panther Trice, Palo Alto, CA (US); W. Allan Clearwaters, Malvern (GB); Arthur Lawida, Scottsdale, AZ (US); Jeffrey W. Curtin, San Jose, CA (US)

Correspondence Address: Robert E. Krebs, P.O. Box 640640, San Jose, CA, 95164-0640, US

(73) Assignee: Similarity, Inc., a Delaware Corporation

(21) Appl. No.: 11/263,350

(22) Filed: Oct. 29, 2005

(51) Int. Cl. A63F 13/00

(52) U.S. Cl. 463/1

(57) ABSTRACT

A method for open market interactive picture portal services comprises configuring one or more engines to support one or more picture games or one or more picture services of an interactive picture game or service system, authoring one or more picture games or one or more picture services for support by the one or more engines, sponsoring at least one of the one or more picture games or picture services, and allowing one or more client having a client device to play the one or more picture games or to use the one or more picture services. The one or more picture games and the one or more picture services comprise the submission of one or more pictures via the client device.

### FIELD OF THE INVENTION

The present invention relates to the field of computer science. More particularly, the present invention relates to interactive pictures.

### BACKGROUND OF THE INVENTION

Typical games and services suffer from one or more deficiencies. Some games and services are not interactive. Some games and services are non-digital. Some games and services are not picture-oriented. Some games and services are not designed for use with mobile devices. Some games and services are not sponsorable by individuals or groups. Some games and services are not designed for local or virtual communities. Some games and services are not found on the Internet. Some games and services are not designed for hand-held devices. Some games and services are not designed for an open market environment. Some games and services are not peer-to-peer. And some games are purely peer-to-peer with no system game functions. And typical solutions do not facilitate the publishing of another author's games or services. There are currently various dedicated SMS (short message service) games with no pictures, real-world photo contests, photo sharing sites, real-world and SMS treasure hunt games, games and services without pictures, photograph-oriented artful manipulation contests for professional photo sites, prize contests with no pictures, and sweepstakes and raffles with no pictures.

Typical photo sites are also limited by one or more deficiencies. Some photo sites lack games. Some photo sites lack an integrated distribution mechanism for picture sharing to other sites or systems. Some photo sites have only photo-type pictures, Some photo sites lack sponsoring of games or services. And some photo sites lack mobile phone support.

Accordingly, a need exists in the art for an improved solution for interactive picture games and services. A further need exists for such a solution that includes mobile device-oriented games and services. A further need exists for such a solution that includes open market authoring, sponsoring, or both. A further need exists for such a solution that includes virtual group, virtual collection, and community support. Yet a further need exists for such a solution for that includes support for features such as contests, prizes, promotions, and affinity programs.

### SUMMARY OF THE INVENTION

A method for open market interactive picture portal services comprises configuring one or more engines to support one or more picture games or one or more picture services of an interactive picture game or service system, authoring one or more picture games or one or more picture services for support by the one or more engines, sponsoring at least one of the one or more picture games or picture services, and allowing one or more client having a client device to play the one or more picture games or to use the one or more picture services. The one or more picture games and the one or more picture services comprise the submission of one or more pictures via the client device.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a block diagram of a computer system suitable for implementing aspects of the present invention.

FIG. 2 is a block diagram that illustrates an interactive picture system in accordance with one embodiment of the present invention.

FIG. 3 is a block diagram that illustrates an interactive picture system from a logical data store with logical engines perspective in accordance with one embodiment of the present invention.

FIG. 4 is a block diagram that illustrates an open market interactive picture games and services publishing system in accordance with one embodiment of the present invention.

FIG. 5 is a high-level flow diagram that illustrates a method for an open market interactive picture games and services publishing portal business in accordance with one embodiment of the present invention.

FIG. 6 is a high-level system flow diagram that illustrates a distributed engine architecture method for an open market interactive picture games and services publishing portal business in accordance with one embodiment of the present invention.

FIG. 7 is a schema diagram that illustrates example transactions for kinds of participants of an interactive picture system in accordance with one embodiment of the present invention.

FIG. 8 is a continuation of FIG. 7.

FIG. 9 is a block diagram that illustrates examples of a method for game/service pattern concepts in accordance with one embodiment of the present invention.

FIG. 10 is a continuation of FIG. 9.

FIG. 11 is a flow diagram that illustrates a method for interactive picture prize-contest game in accordance with one embodiment of the present invention.

FIG. 12 is a continuation of FIG. 11.

FIG. 13 is a flow diagram that illustrates a method for interactive picture prize-contest game judging in accordance with one embodiment of the present invention.

FIG. 14 is a block diagram that illustrates an interactive picture application system comprising an interactive picture contest system in accordance with one embodiment of the present invention.

FIG. 15 is a block diagram and schema that illustrates a method for client and message identification for an interactive picture system in accordance with one embodiment of the present invention.

FIG. 16 is a schema diagram that illustrates example game modes for an interactive picture game system in accordance with one embodiment of the present invention.

FIG. 17 is a schema diagram that illustrates example game categories for an interactive picture game system in accordance with one embodiment of the present invention.

FIG. 18 is a schema diagram that illustrates example services for an interactive picture service system in accordance with embodiments of the present invention.

FIG. 19 is a schema diagram that illustrates example virtual organization types for an interactive picture game/service system in accordance with one embodiment of the present invention.

### DETAILED DESCRIPTION

Embodiments of the present invention are described herein in the context of a method and apparatus for interactive pictures. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

According to one embodiment of the present invention, the components, process steps, structures, or any combination thereof, may be implemented using various types of operating systems (OS), computing platforms, firmware, computer programs, computer languages, general-purpose machines, or any combination thereof. The method can be run as a programmed process running on processing circuitry. The processing circuitry can take the form of numerous combinations of processors and operating systems, connections and networks, data stores, or a stand-alone device. The process can be implemented as instructions executed by such hardware, hardware alone, or any combination thereof. The software may be stored on a program storage device readable by a machine.

According to one embodiment of the present invention, the components, processes data structures, or any combination thereof, may be implemented using machine language, assembler, C or C++, Java, other high level language programs running on computers (such as running windows XP, XP PRO, CE, 2000K (other windows), Linux or Unix, Solaris, Palm, or Apple OS X based systems), or any combination thereof. According to one embodiment of the present invention, the processes may be implemented using a distributed component management and run-time deployment tool such as MOJO, by Object Forge, LTD of the United Kingdom. Different implementations may be used and may include other types of operating systems, computing platforms, computer programs, firmware, computer languages, general-purpose machines, or any combination thereof; and may also include various CCD cameras, color cameras, infrared cameras, analog cameras, digital cameras, video cameras, still picture cameras, mobile cameras, stationary cameras, and other types of sensor devices. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

According to one embodiment of the present invention, the method may be implemented on a data processing computer such as a personal computer, workstation computer, mainframe computer, or high performance server running an OS such as Solaris® available from Sun Microsystems, Inc. of Santa Clara, Calif., Microsoft® Windows® XP and Windows® 2000, available from Microsoft Corporation of Redmond, Wash., or various versions of the Unix operating system such as Linux available from a number of vendors. The method may also be implemented using mobile phones, such as those sold by Nokia and Ericsson, etc. The method may also be implemented on a mobile device running an OS such as Windows® CE, available from Microsoft Corporation of Redmond, Wash., Symbian OS™, available from Symbian Ltd of London, UK, Palm OS®, available from PalmSource, Inc. of Sunnyvale, Calif., and various embedded Linux operating systems. Embedded Linux operating systems are available from vendors including MontaVista Software, Inc. of Sunnyvale, Calif., and FSMLabs, Inc. of Socorro, N. Mex. The method may also be implemented on a multiple-processor system, or in a computing environment including various peripherals such as input devices, output devices, displays, digital cameras, mobile phones, digital video cameras, mobile computing devices, pointing devices, memories, storage devices, media interfaces for transferring data to and from the processor(s), and the like. In addition, such a computer system or computing environment may be networked locally, or over the Internet or other networks.

In the context of the present invention, the term “connection means” includes any means by which a first one or more devices communicate with a second one or more devices. In more detail, a connection means includes networks and direct connection mechanisms, parallel data busses, and serial data busses.

In the context of the present invention, the term “network” includes local area networks, wide area networks, metro area networks, residential networks, personal area networks, corporate networks, inter-networks, the Internet, the World Wide Web, ad-hoc networks, peer-to-peer networks, server networks, backbone networks, cable television systems, telephone systems, wireless telecommunications systems, WiFi networks, Bluetooth networks, SMS networks, MMS networks, fiber optic networks, token ring networks, Ethernet networks, ATM networks, frame relay networks, satellite communications systems, and the like. Such networks are well known in the art and consequently are not further described here.

In the context of the present invention, the term “identifier” describes an ordered series of one or more numbers, characters, symbols, or the like. More generally, an “identifier” describes any entity that can be represented by one or more bits.

In the context of the present invention, the term “processor” describes a physical computer (either stand-alone or distributed) or a virtual machine (either stand-alone or distributed) that processes or transforms data. The processor may be implemented in hardware, software, firmware, or a combination thereof.

In the context of the present invention, the term “data stores” describes a hardware means or apparatus, a software means or apparatus, or a hardware and software means or apparatus, either local or distributed, for storing digital or analog information or data. The term “Data store” describes, by way of example, any such devices as random access memory (RAM), read-only memory (ROM), dynamic random access memory (DRAM), static dynamic random access memory (SDRAM), Flash memory, hard drives, disk drives, RAID storage, floppy drives, tape drives, CD drives, DVD drives, magnetic tape devices (audio, visual, analog, digital, or a combination thereof), optical storage devices, electrically erasable programmable read-only memory (EEPROM), solid state memory devices and Universal Serial Bus (USB) storage devices, and the like. The term “Data store” also describes, by way of example, databases, file systems, record systems, object oriented databases, relational databases, multidimensional databases, SQL databases, audit trails and logs, program memory, cache and buffers, and the like.

In the context of the present invention, the term “user interface” describes any device or group of devices for presenting information to or from persons or animals, receiving information to or from persons or animals, or both. A user interface may comprise a means to present information to persons or animals, such as a visual display projector or screen, a loudspeaker, a light or system of lights, a printer, a Braille device, a vibrating device, or the like. A user interface may also include a means to receive information or directions from persons or animals, such as one or more or combinations of buttons, keys, levers, switches, knobs, touch pads, touch screens, microphones, speech detectors, motion detectors, cameras, and light detectors. Exemplary user interfaces comprise pagers, mobile phones, desktop computers, laptop computers, handheld and palm computers, personal digital assistants (PDAs), cathode-ray tubes (CRTs), keyboards, keypads, liquid crystal displays (LCDs), control panels, horns, sirens, alarms, printers, speakers, mouse devices, consoles, and speech recognition devices.

In the context of the present invention, the term “system” describes any computer information device, computer control device, device or network of devices, comprising hardware, software, or both, which comprise a processor means, data storage means, program means, user interface means, or combination thereof, and which is adapted to communicate with the embodiments of the present invention, via one or more data networks or connections, and is adapted for use in conjunction with the embodiments of the present invention.

In the context of the present invention, the term “alarm” describes any means for alerting, notifying, or getting the attention of persons or animals. An alarm may be adapted to indicate a danger, a warning, urgency, a need for alert, attention, or import. Exemplary alarms comprise sirens, horns, ring tones, beeps, lights, blinking lights, flashing lights, vibrations, print outs, gauges, symbols, and visual displays, and the like.

In the context of the present invention, the term “sensor” describes any device adapted to sense at least one change or differential in a physical environment or object. Sensors may be visual sensors or non-visual sensors. Exemplary visual sensors comprise color cameras and infrared cameras. Such cameras may be video cameras, still cameras, or both. Such cameras may also be analog cameras, digital cameras, or both. Non-visual sensors comprise sensors for detecting non-visual aspects of an event. Exemplary non-visual passive sensors comprise magnetic sensors, heat sensors, sound sensors, microphones, vibration sensors, motion detectors, radiation detectors, and the like. Exemplary non-visual active sensors comprise RFID readers, smart card readers, transponder devices, and other card and device readers.

In the context of the present invention, the term “picture” describes any digital visual media such as photographs, still photographs, images, moving pictures, video, films, shorts, edited or manipulated photographs, edited or manipulated video, drawings, paintings, slide decks, line drawings, sketches, computer generated images, animated films, commercial films, television shows, commercials, home video, security video, security photographs, monitor video, monitor photographs, satellite images, aerial images, underwater images, space images, medical images, video art, graphics, art graphics, animal art, machine art, nature generated art, composites of any of the above, or hybrids of any of the above. Such pictures may be encoded in various forms or standards known now or in the future, such as jpeg, bmp, tiff, mpeg, wmv, etc. Such pictures may also be singular or in collections, including composite or hybrid mixes, structured or unstructured. Pictures may be the product of accident, intent, design, natural, mechanical, or computing process. Pictures also may be constructed, recorded, live, streaming, etc. Pictures may include associated other information, data, meta-data, XML, RDF, text, symbols, sound, music, etc.

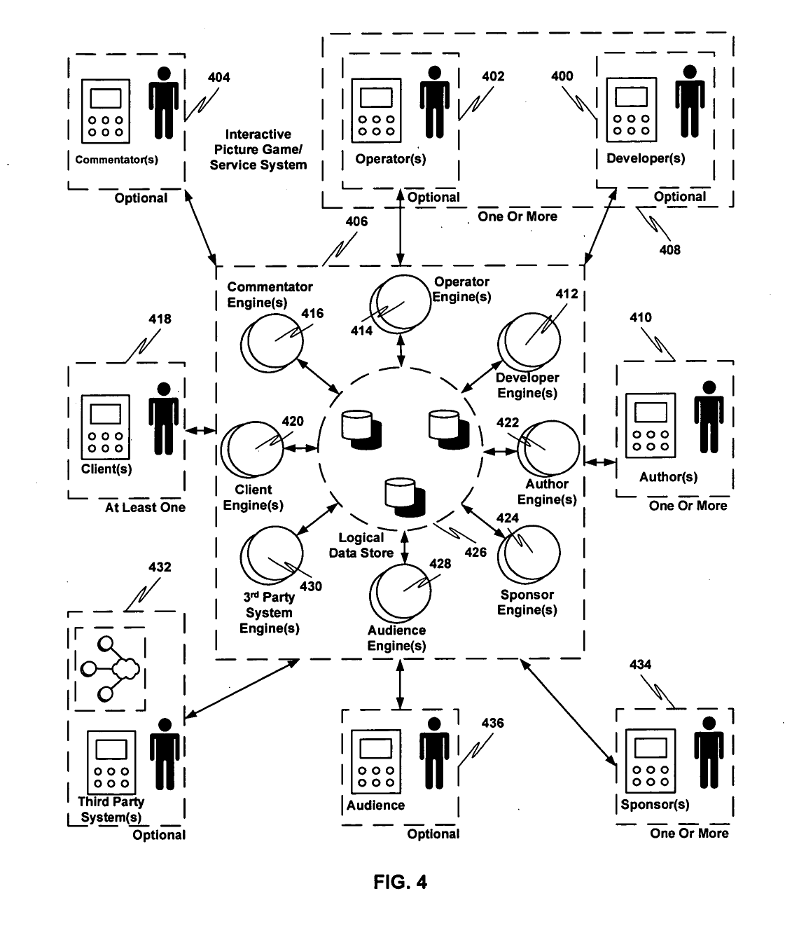

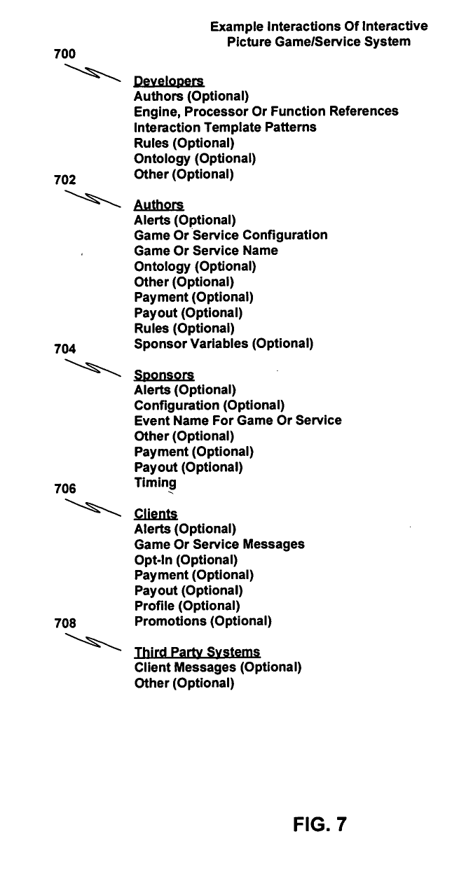

In the context of the present invention, the term “developer” describes one or more humans or automated systems that create or adjust a functional component that realizes or enables one or more aspects of one or more games or services or interactive picture game or service systems or game/service patterns or engines, or any combination(s) or component(s) thereof. Such functional components may be hardware or software or functional equivalent or any combination thereof. Examples include without limitation, a programmer, engineer, field engineer, systems engineer, designer, software engineer, game designer, game engineer, pattern engineer, games master, automated developer, human developer, architect, designer, coder, tester, etc. See FIGS. 4 and 7 and accompanying description, below.

In the context of the present invention, the term “judge” describes a participant who performs judging for an interactive picture game. See FIGS. 4, 8, 6, 12, 13 and 14 and accompanying description, below.

In the context of the present invention, the term “operator” describes any machine operator, human operator, robot operator, automated operator, system administrator, system manager, etc. See FIGS. 4, 8, and 14 and accompanying description, below.

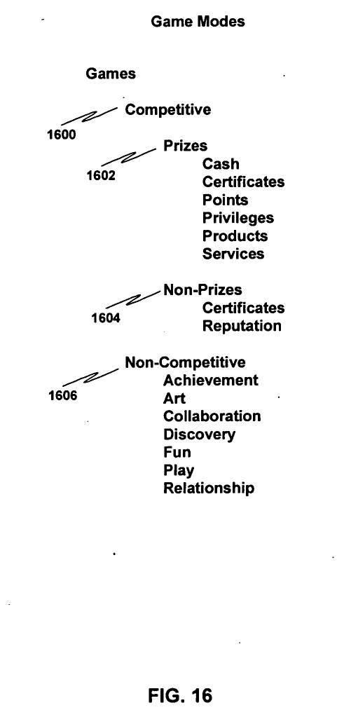

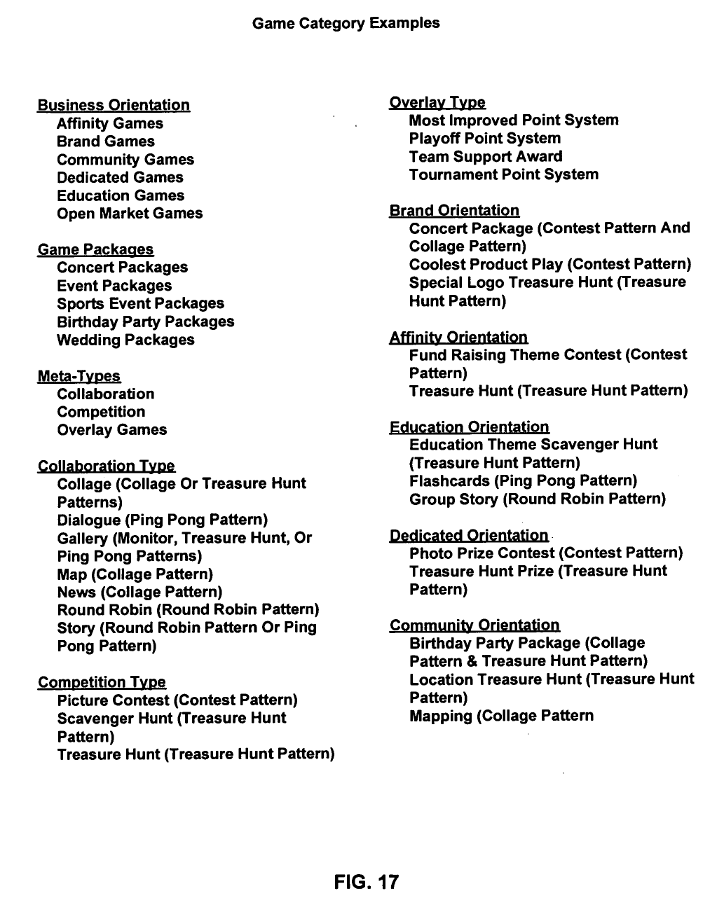

In the context of the present invention, the term “game” describes message interactions with one or more client players for play or competition or collaboration. Games may have prizes awarded. There may be games with and without fees. Games include, but are not limited to the types of games described in FIG. 17. Games include, without limitation, the categories described in FIG. 16.

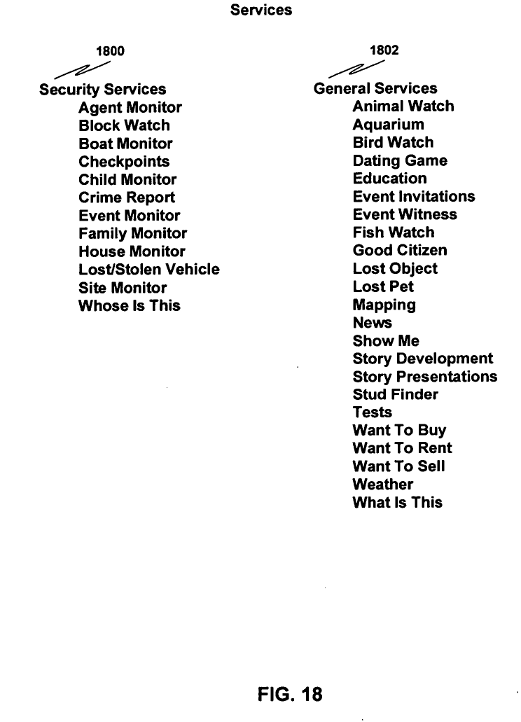

In the context of the present invention, the term “service” describes message interactions with one or more clients for use or utility. Services include, without limit, security oriented and service oriented utility as is described in FIG. 18.

In the context of the present invention, the term “overlay-game” describes any game based on events or processes across one or more other games, such as tournaments, point systems, point spreads, playoffs, etc. See FIG. 17 and accompanying description, below.

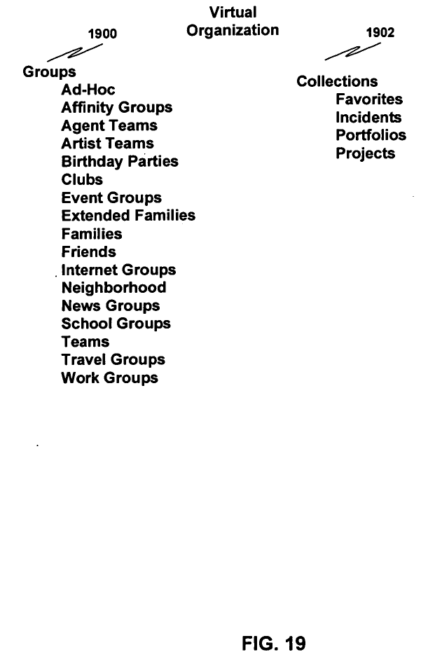

In the context of the present invention, the term “portfolio” describes any collection of one or more pictures, for example, without limit, a list, set, album, favorites list, links page, set of references, blog, etc. Portfolios may be nested, overlapping, or both. Portfolios may include additional associated data, meta-data, text, symbols, names, etc. See FIG. 19 and accompanying description, below.

In the context of the present invention, the term “group” describes any collection of members, clients, participants, authors, sponsors, operators, developers, audience, third party systems, identities. Groups may be nested, and members may belong to more than one group. Groups may be created ad-hoc for participants meeting certain common criteria. See FIG. 19 and accompanying description, below.

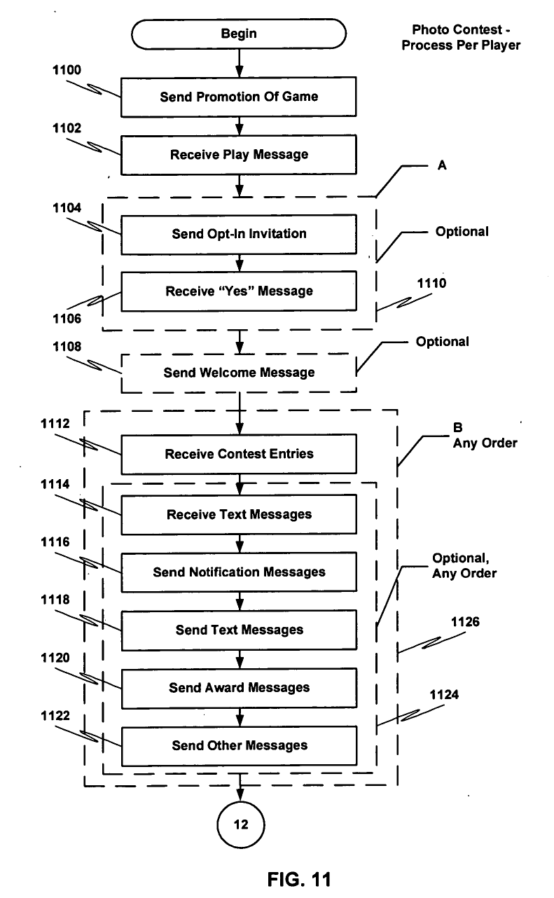

In the context of the present invention, the term “prize” describes, without limitation, awards to client players of games, which may be cash, products, services, tickets, gifts, certificates, privileges, points, or special items (e.g. achievement prizes and the like). Prizes may awarded, without limitation, for one or more best places in a competition, for one or more worst places in a competition, for points, for participation in a certain order or time, at a certain place, randomly, or for any other criteria. Prizes may be determined, without limitation by the game operators or chosen from list or other sources by the player. Prizes may be fixed prior to the game, or dynamically calculated before, during or after a game, for example as a percentage of the purse collected through pay-to-play or other fees for a game or from previous games. See FIGS. 11, 12, and 13 and accompanying description, below.

In the context of the present invention, the term “contest” describes, without limitation, games which are played competitively where there are criteria for judging or awarding best prizes, worst prizes, and any other prizes as well. Awards may be prizes, or other non-prize awards such as certificates, public notices, etc. See FIGS. 17, 11, 12, 13, and 14 and accompanying description, below.

In the context of the present invention, the term “judging” describes the activity of selecting game entries or plays, including pictures, for their position in a competitive game. Judging may be by human judges, automated process, by selection by animals, or by detection of other events in association with an entry or play. See FIGS. 4, 13 and 14 and accompanying description, below.

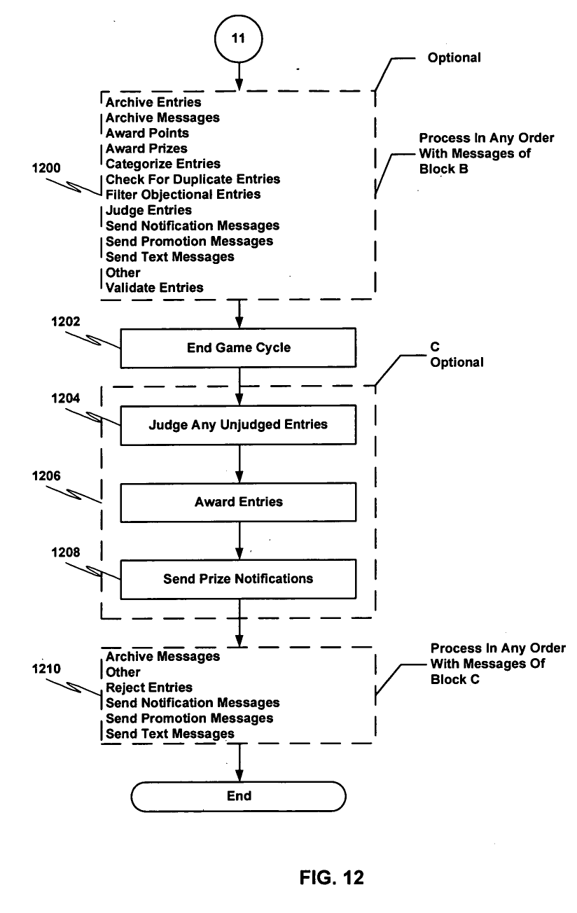

In the context of the present invention, the term “frequent participant points” describes, without limitation, counters of value awarded and accumulated by or for participants as prizes or for participation in picture games or services which provide some value to the participant. The provided value, without limitation, may be to exchange points for products, services, privileges, special items, further participation, etc. Frequent participant points may, without limitation, apply to authors, sponsors, clients, audience, commentators, judges, any combination thereof, etc. See FIGS. 11 and 12 and accompanying description, below.

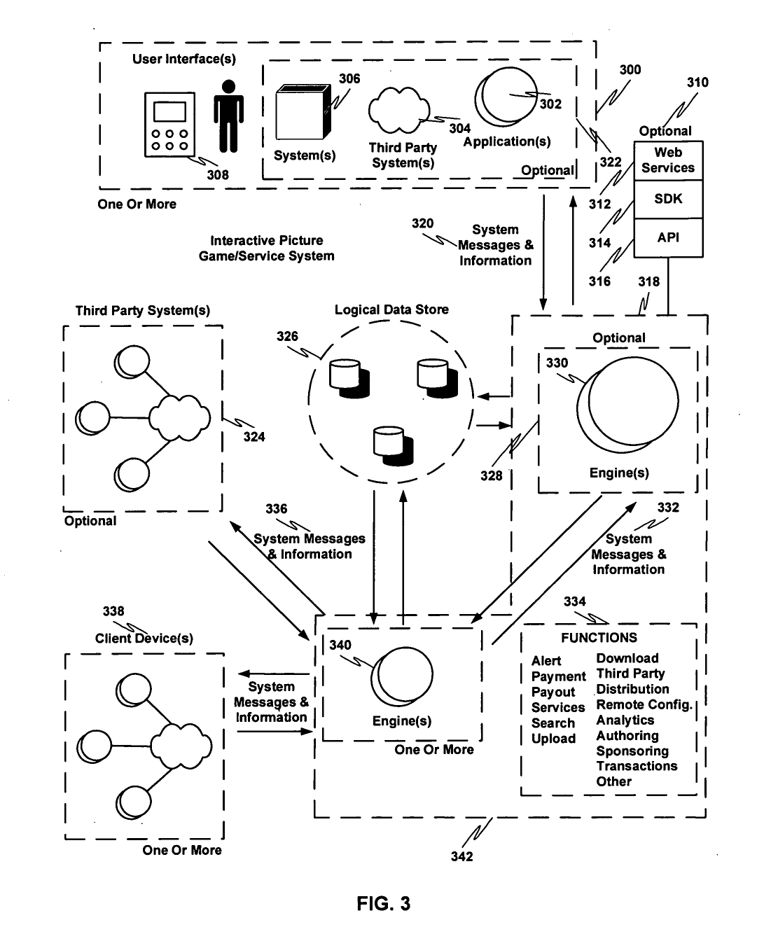

In the context of the present invention, the term “engine” describes a component comprising hardware, software, firmware, or any combination thereof for performing a function. An engine may be, without limitation, singular or plural, dedicated or distributed, structured or unstructured, a process, a task, an object, a procedure, a function, or any combination thereof. See FIGS. 3, 4, 6 and 14 and accompanying description, below.

In the context of the present invention, the term “purse” describes an amount of value collected from game fees. A purse may be accumulated for one game or over more than one game or percentages of each.

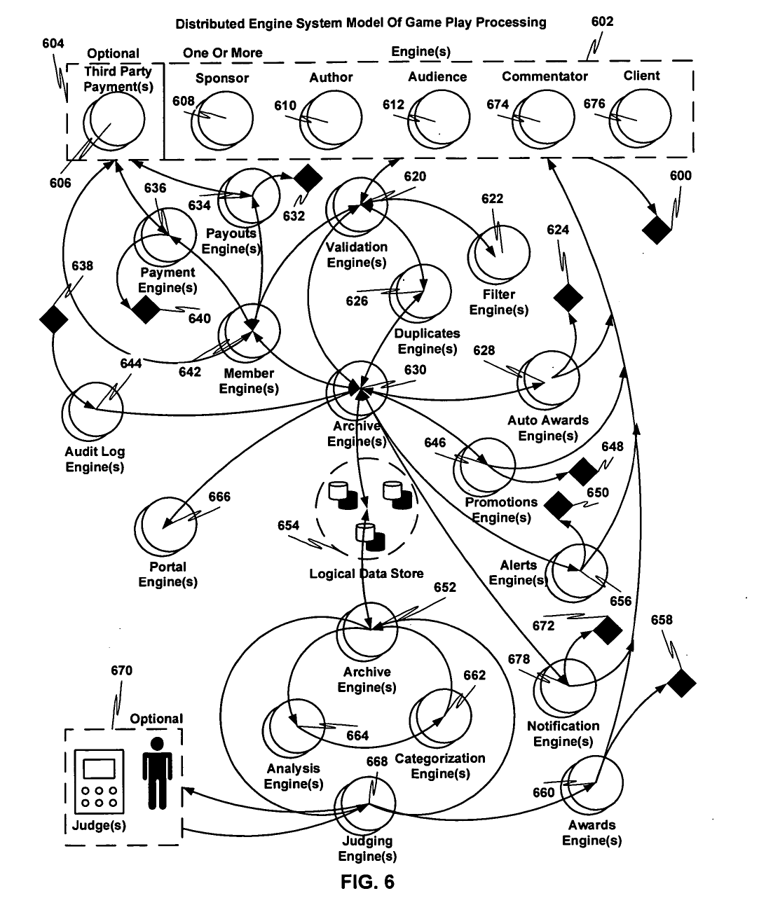

In the context of the present invention, the term “promotion” describes endeavors to gain or increase participants, any aspect of participation in an activity, or both. Promotions include the use of emails, SMS messages, flyers, brochures, advertising in any form, sales programs, marketing programs, pricing strategies, and messages to potential participants. Promotions may be single endeavors or programs or projects organizing many endeavors. The term ‘Promotions’ may also describe one or more messages exchanged with a participant as part of a promotion endeavor. See FIGS. 7, 8, 11, 12 and 6 and accompanying description, below.

In the context of the present invention, the term “game participant” or “service participant” means one or more humans, automated systems, or both, that may act as, without limitation, client, author, sponsor, audience member, reviewer, judge, or other in regard to a game or service.

In the context of the present invention, the term “notification” describes a message sent to inform a game or service participant. Notifications may be, without limitation, about past, current, or future situations or events. See FIGS. 7, 8, 11, 12 and 6 and accompanying description, below.

In the context of the present invention, the term “message” describes an ordered series of one or more bits, numbers, characters, symbols, or the like, intended to transfer or carry information between one or more entities or systems. Examples include one or more of SMS messages, MMS messages, telecommunications messages, information packets, information transmissions, coded communications, etc. A message may contain all or any part, in any coding, of text, symbols, graphics, language, instructions, codes, numbers, patterns, pictures, data, meta-data, identifiers, time stamps, counters, names, addresses, etc. One or more messages may be exchanged between parties, for example, without limitation, in the process of a transaction or function or game or service cycle. See FIGS. 11 and 12 and accompanying description, below.

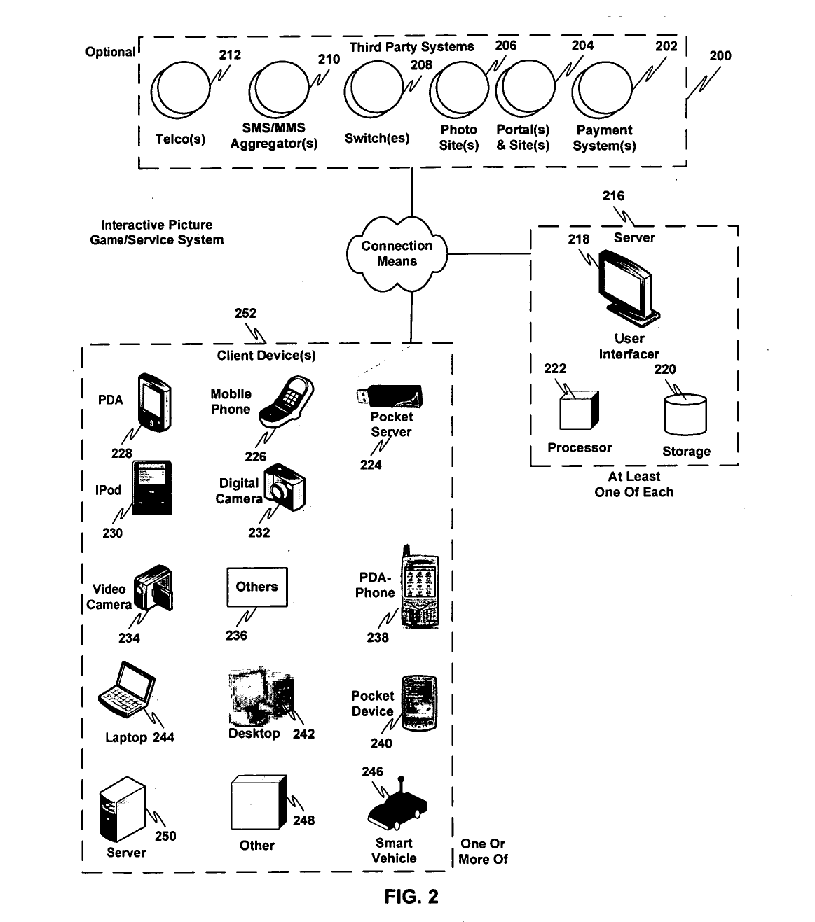

In the context of the present invention, the term “third party system” describes a business or automated processing system which is not a logical part of the currently described interactive picture game and service system, and which, through the exchange of messages, may provide functions and/or system or business process. A system is not a “logical part” of the embodiments of the present invention, based on one or more of geographic, ownership, business, technical, and legal considerations. Examples of third party systems, without limitation, include payment systems, member card systems, aggregators or switches of SMS and/or MMS messages, message or transaction aggregators or brokers or switches or dispatchers, credit bureaus, police systems, license systems, corporate systems, web services, photo service servers, print shop systems, TiVo®, archival systems, photo sharing sites or portals, personal web sites or servers, corporate web sites or servers, organization web sites or servers, bank systems, casino systems, government systems, other interactive picture game or service systems, etc. See FIGS. 2, 3, 4, and 6 and accompanying description, below.

In the context of the present invention, the term “payment system” describes third party systems that provide business or system processes for making payment exchanges between parties. Exchanges may be large or small, closed or open, regional or national or international, real-time or non-real-time, of currency or points or other value, etc. Exchanges may be of standard values, micro-payments, stored value, account value, identified or anonymous, foreign or local currencies, wires, money orders, checks, drafts, letters of credit, services, etc. Examples of payment systems include, without limit, Bitpass, PayPal, Visa, MasterCard, American Express, other credit card systems, debit card systems, banking systems, Western Union, Google Wallet, etc.

In the context of the present invention, the term “prize roll-forward” describes a function of deferring the delivery or transfer of prize value to a participant in order to carry that value forward to apply to a future prize delivery or transfer possibly including accumulated value of more than one deferred prize. A prize roll-forward amount may expire or change in other ways after a period of time or upon certain conditions.

In the context of the present invention, the term “author” describes a participant who creates or develops a game or service using tools meeting that function for an interactive picture game or service system. See FIGS. 7 and 4 and accompanying description, below.

In the context of the present invention, the term “sponsor” describes a participant who chooses one or more games or services, from an interactive picture game or service system or portal, to realize as playable or usable by one or more potential clients. See FIGS. 7 and 4 and accompanying description, below.

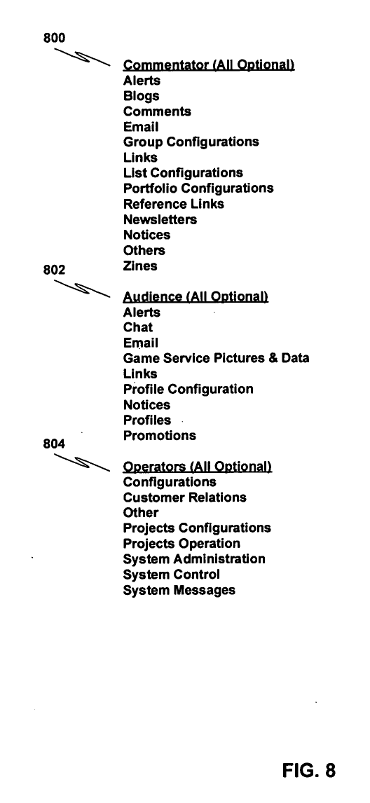

In the context of the present invention, the term “alert” describes a notification transaction about a current or near time event or state which is urgent, has been requested by the participant, or both. According to one embodiment of the present invention, for example, without limitation, alerts may include, notification of imminent end of a current game cycle, notification of an error or problem with a current game or service transaction, notification of a friend joining a game, etc. See FIGS. 7 and 8 and accompanying description, below.

In the context of the present invention, the term “membership” describes the state of a participant regarding information structure and data for their participation which enables their transactions across one or more game/service cycles. According to one embodiment of the present invention, for example, without limitation, the state of a client's membership may be comprised of, in part, name, profile, phone number, email address, non-existent or ad-hoc or regular, active or inactive, paid or unpaid, full or partial, last game played, desired prizes list, prize roll-forward value, etc. See FIG. 6 and accompanying description, below.

In the context of the present invention, the term “ad-hoc membership” describes a function of creating an immediate membership for an unrecognized game or service client or group at the time they initiate game or service message exchange with an interactive picture game or service system. Such a membership would be based, for example, on one or more identities available in the messages of the relevant exchange. Examples of such identities may include, without limitation, phone number, device id, email address, network address, etc. An ad-hoc membership may expire, for example without limitation, at the completion of the initiating game or service cycle, or after a period of time of no activity, etc. According to one embodiment of the present invention, an ad-hoc membership is for a concert game where new clients choose to play the concert game without having previously registered or been a participant of any game or service of the present system; as those clients, for example, initiate a game from their mobile phones by SMS or MMS or email message the system will check to see if they have a current membership and if they do not it will create an ad-hoc membership for them by their phone number or email address, and will use that ad-hoc membership to maintain their status through game play and for message exchange with them and game judging awards and subsequent promotions, etc. See FIGS. 19 and 6 and accompanying description, below.

In the context of the present invention, the term “profile” describes membership information associated with a participant or group for enabling the transactions they participate in and for sharing, in full or part, with other one or more other participants, kinds of participants, or both. See FIG. 7 and accompanying description, below.

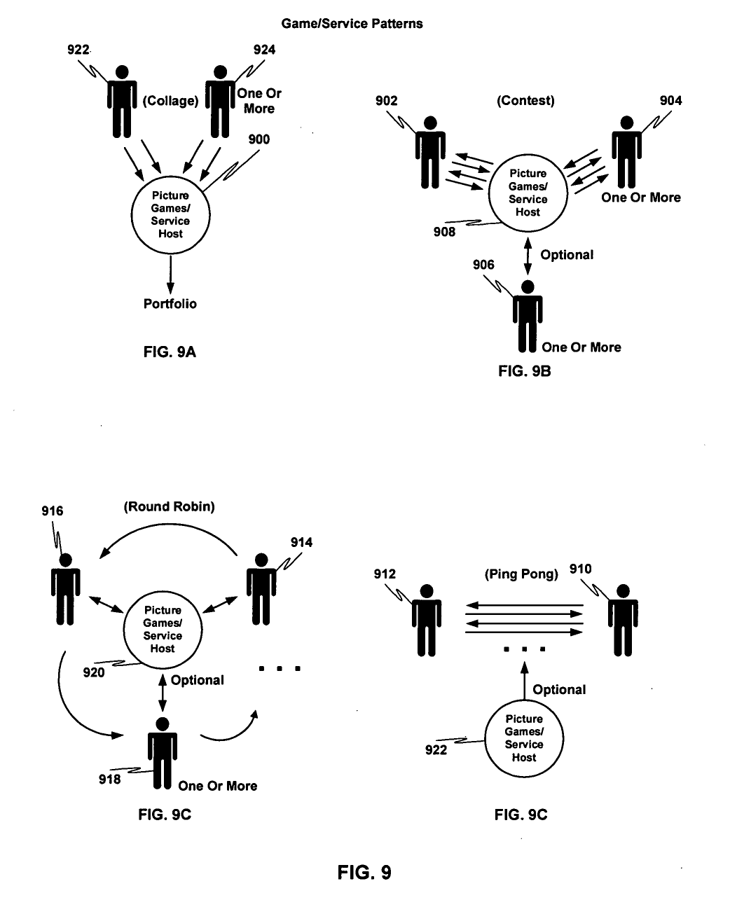

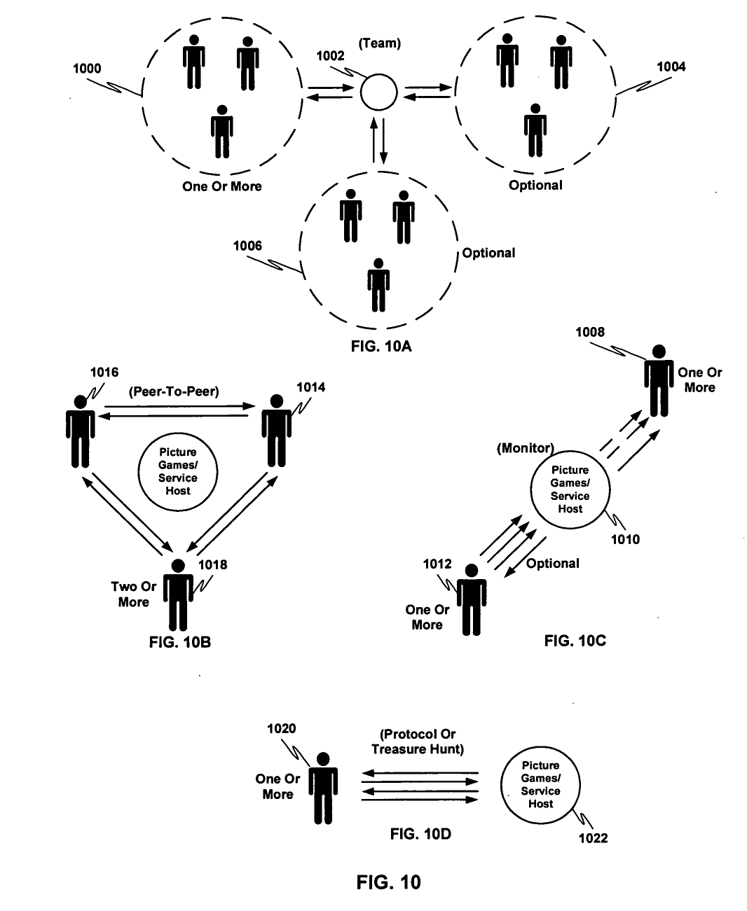

In the context of the present invention, the term “game/service pattern” describes the common structure of, for example, without limitation, messages, transactions, and functions comprising a similar set of games. According to one embodiment of the present invention, game/service patterns are coded into the logical data store or into an engine using one or more of OWL ontology language tools, RDF language tools, rules, XML, other data, or any combination thereof. See FIGS. 9 and 10 and accompanying description, below.

In the context of the present invention, the term “client engine” describes an engine providing transaction functionality for interfacing with a client device for the purpose of game and service transactions, other transactions, or both. In one embodiment of the present invention, for example and without limitation, a client engine may be comprised of in part game patterns for the games transactions it supports and be comprised of in part, for example, closed world OWL engines and other rules engines and system components and other system component references, engine references, or both. See FIG. 7 and accompanying description, below.

In the context of the present invention, the terms “game cycle” and “service cycle” respectively describe the transactions, functions, or both, including, without limitation, of, respectively executing a game from start to finish, and a service function from start to finish. See FIG. 12 and accompanying description, below.

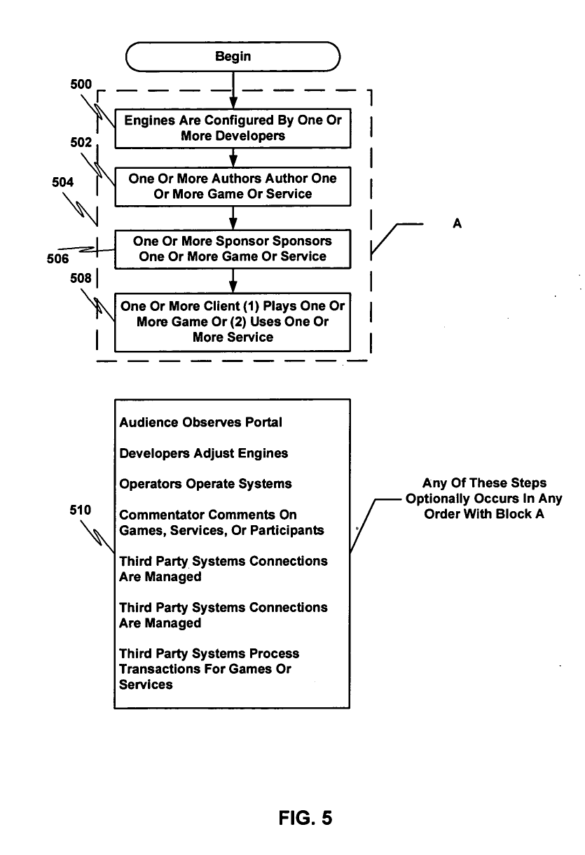

In the context of the present invention, the term “managing” describes the transactions or functions, including, without limitation, creating, adding, changing, deleting, organizing, moving, copying, duplicating, launching, starting, stopping, pausing, connecting, disconnecting, and/or archiving system information or components. By way of example, “managing” includes connecting and disconnecting communications with third party systems, launching, stopping engines, creating memberships, deleting memberships, moving portfolios, copying portfolios, creating portfolios, changing profiles, or any combination thereof, etc. See FIG. 5 and accompanying description, below.

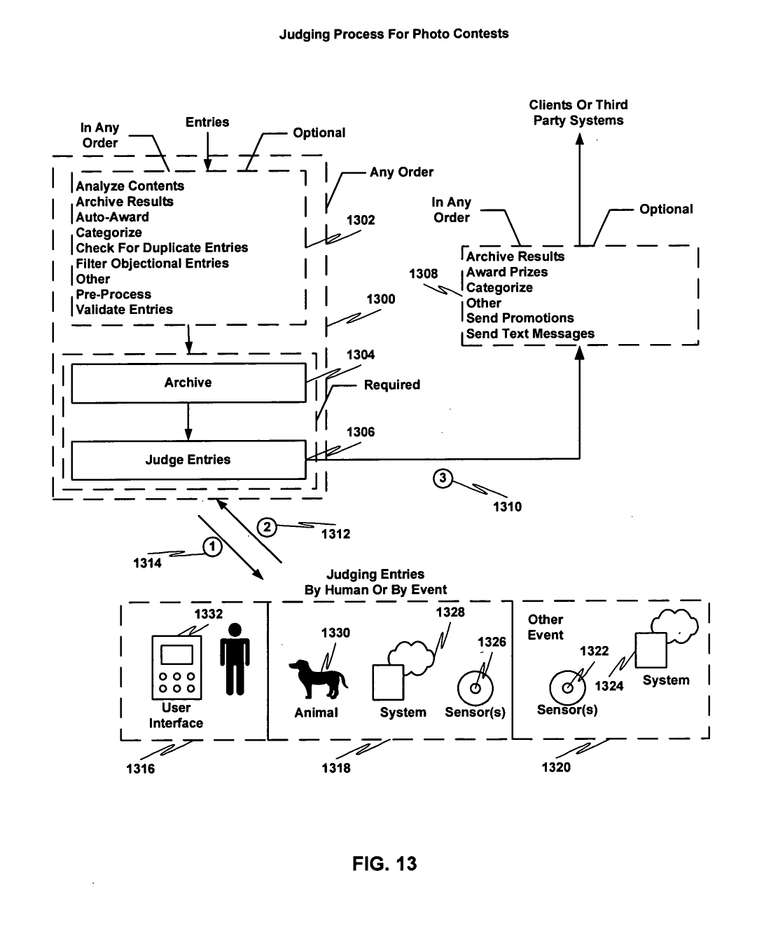

In the context of the present invention, the term “other event” describes a random or pseudorandom event detectable by a sensor device for use in determining a selection for judging transactions. By way of example, “other events” include weather events, clock events, geological events, sound events, radiation events, entertainment events, sports events, news events, etc. See FIG. 13 and accompanying description, below.

In the context of the present invention, the term “animal” describes an animal as that term is commonly defined biologically and participating as a judge. By way of example, an “animal” includes, without limitation, an elephant, a dog, a bird, a mouse, an octopus, a dolphin, a monkey, a fish, etc. For example as a judge an elephant may be presented the top 10 pictures of a contest as currently judged and by sensing the responses of the elephant to the images select the first, second and third prize awards. See FIG. 13 and accompanying description, below.

In the context of the present invention, the term “analytics” describes algorithms or functions, that may for example be implemented in an engine, that analyze the contents of one or more pictures, messages, transactions, or any combination thereof, for patterns to be used in further functions or engines. By way of example, “analytics” include, without limitation, a function to create indexes of the contents of pictures for use in later search functions and check for duplicate functions, a function to auto categorize or rank game pictures to reduce the judging work of judges, or to auto-judge certain game transactions. See FIG. 6 and accompanying description, below.

In the context of the present invention, the term “download” describes a transaction for loading all or part of an engine or application or picture or portfolio or data from an interactive picture game or service system to a participant device or system. Examples include, without limitation, client devices, author devices or systems, sponsor devices or systems, third party systems, etc. See FIG. 3 and accompanying description, below.

In the context of the present invention, the term “transaction” describes a logical virtual component of functionality comprised of one or more messages exchanged and their associated processing such that a logical unit of business function, system function, or both, is executed. A transaction may, for example, complete properly or fail, etc. Transactions may arranged in various structures as are well known in the art; examples are nested, chained, branched, etc. By way of example, “transactions” include, without limitation, payment transactions, submitting a picture as an entry in a contest game, registering as a member, opt-in transactions for a game cycle, requesting a service and receiving a response, etc. See FIG. 3 and accompanying description, below.

In the context of the present invention, the term “pocket server” describes a small mobile computing device, optionally without its own user interface features, capable of housing engines or applications, running engines or applications, or both, in order to execute participant transactions of an embodiment of an interactive picture game or service system. A pocket server may occupy the architectural role of a server in a local network, a personal network, or both. Examples of pocket servers include, without limitation, smart cards, Trusted Flash by SanDisk, disk2go®SMART by U3, flash memory card devices like Trusted Flash and including network capabilities and one or more engines, etc. See FIG. 2 and accompanying description, below.

In the context of the present invention, the term “SMS/MMS aggregators” describes third party systems that aggregate or broker or switch SMS messages MMS messages, other telecommunications messages, or any combination thereof, from client devices. Example client devices include, without limitation, mobile phones and PDA-Phones. Example SMS/MMS aggregators include, without limitation, Mobile365, etc. The term “SMS/MMS aggregators” is also intended to include other message and protocol technologies of equivalent or similar functionality. See FIG. 2 and accompanying description, below.

In the context of the present invention, the term “client device” describes a computing device used by a client to play one or more games, to use one or more services, or both, of an interactive picture game or service system. Examples of client devices include, without limitation, PDAs, mobile phones, pocket servers, iPods, digital cameras, video cameras, PDA-phones, laptops, desktops, pocket devices, servers, smart autos, laptops, palmtops, handhelds, eyeglass systems, desktop systems, kiosk systems, cyber-café stations, and any combination thereof, etc. A client device may be configured with Global Positioning System (GPS) functionality. See FIG. 2 and accompanying description, below.

In the context of the present invention, the term “third party distribution” describes a function of managing, moving or copying one or more pictures or other participant information at or to one or more third party systems. Examples of such third party distribution may include, without limitation, copying client pictures to a photo sharing web site that the client also uses, for example, flikr or ophoto; moving client pictures to the client's home TiVo system; or moving a work team's group portfolio of pictures to their employer's corporate server. See FIG. 3 and accompanying description, below.

In the context of the present invention, the term “remote config” describes a function of managing configuration information for a distributed engine by message exchange with another remote server, system, or device. An example of one embodiment of this invention is for an interactive picture game or service system where the configuration information stored or operating local to an engine of a client device is managed through a browser from a page on the interactive picture game or service system portal, and optionally where a duplicate of that information is managed synchronously with a client or device profile on the portal. Another example embodiment is for the similar function for a pocket server which has no local UI capabilities and no corresponding function available locally. See FIG. 3 and accompanying description, below.

In the context of the present invention, the term “commentator” describes a participant who participates, for example, without limitation, in transactions to publish or comment on pictures, games, services, profiles, other information, and any combination thereof. By way of example, commentators may publish game reviews in blogs, participant reviews with profile references in e-zines, collections of select pictures in portfolios, event promotions to email mailing-lists and notification groups, game collections as favorites lists, cool reference bookmarks in favorites lists, etc. A commentator may perform one or more of the following functions: editor, reviewer, critic, promoter, aficionado, fan club leader, activist, cheerleader, publisher, distributor, blogger, reporter, commentator, expert, appraiser, gourmet, producer, marketer, salesperson, columnist, cartoonist, missionary, evangelist, prophet, cool hunter, futurist, tipping point agent, agent, manager, coach, odds maker, etc. See FIGS. 4 and 8 and accompanying description, below.

In the context of the present invention, the term “projects” describes a collection including any one or more of but not limited to, links, references, bookmarks, pictures, profiles, games, authoring activities, sponsoring activities, or other, etc. According to one embodiment of the present invention, projects include a portfolio of project items related to a game in mid authoring, a portfolio of project items related to a game team's activities, a favorites list of potential sponsors for an author's game and a group of frequent players, a group of block watch participants and portfolio of portfolios of block watch pictures by date, etc. See FIG. 19 and accompanying description, below.

In the context of the present invention, the term “incidents” describes security-related projects for support of investigation to signification security events, response to significant security events, or both. According to one embodiment of the present invention, “incidents” include a portfolio of pictures of a security related event and a favorites list of profiles of participants involved in the incident, a portfolio of a month of portfolios of events for a specific site and specific time by date and associated blog links and a favorites list of email addresses for involved parties, etc. See FIG. 19 and accompanying description, below.

In the context of the present invention, the term “team” describes a group of participants for playing a game together as a team or using a service together as a team. According to one embodiment of the present invention, a team includes: a group for collecting a collage of pictures for a newsworthy event, each of several groups of participants playing together in a treasure hunt game where all the participants in a particular team must each satisfy the current clue before the next clue is sent to all the team members at the same time, a group of participants playing together in a scavenger hunt game where each team member can play for the scavenger stations in different orders and all the team participants must each complete all the scavenger stations before the team completes the game, a group of agents investigating an area where each agents investigation pictures are filling in pieces of a collage displayed in a map to guide efficient coverage of the area, etc. See FIGS. 19 and 10 and accompanying description, below.

In the context of the present invention, the term “smart vehicle” describes a vehicle with communication means and incorporated computing resources and capable of performing all or part of the functions of a client device. According to one embodiment of the present invention, smart auto include: a motorcycle with an incorporated camera, a PDA and communication means, all organized in a local network, such that the motorcycle camera can monitor the area in front of the vehicle to be recorded for an audit trail record; a car with incorporated communication means and storage means connected in a local network such that pictures from a digital camera can be moved to storage in the car, a bus with incorporated client devices for each seat for the use of client riders for playing picture games during the bus ride, etc. According to another embodiment of the present invention, a smart vehicle includes any of the following vehicles: ground craft such as cars, automobiles, trucks, trailers, vans, SUVs, motorcycles, all-terrain vehicles (ATVs), carts, scooters, bicycles, military vehicles, heavy equipment, trains, cable cars, snowmobiles, and the like. Exemplary vehicles also comprise watercraft such as submersibles, amphibious craft, ships and boats, hydroplanes, personal watercraft, and the like. Exemplary vehicles also comprise aircraft such as airplanes, jet aircraft, gliders, balloons, helicopters, and the like. Exemplary vehicles also comprise spacecraft such as shuttles, stations, rockets, satellites, and the like. Exemplary vehicles also comprise containers such as boxes, shipping containers, and the like. See FIG. 2 and accompanying description, below.

In the context of the present invention, the term “achievement prize” describes products reserved for awards as prizes limited to participants who meet certain achievement criteria. According to one embodiment of the present invention, ‘achievement prize’ includes: a t-shirt, coffee mug, keychain, messenger bag, cap, bandanna, scarf, socks, badges, pins, pens, paperweights, gloves, belt buckles, backpacks, rings, patches, tattoos, hair accessories, bags, purses, shoelaces, camera bags, mobile phone pouches, accessory pouches, computer sleeves, clothing items, sports items, tools, devices, other items, or any combination thereof, each of one or more achievement prize designs. According to one embodiment of the present invention, achievement prizes awards include: a limited design cap awarded only to clients for winning 1^{st} prize 3 times; a limited design leather jacket awarded only to authors of a game that has achieved 100,000 plays, a limited design pair of earrings only for sponsors who have raised $50,000 in funds for an affinity group through their sponsored games; a limited design flashlight only for block watch clients who successfully reported a crime in progress which was subsequently foiled by officials, a limited design scarf only for sponsors of neighborhood interactive picture games and services that significantly improved the sustained quality of life in the neighborhood, etc. According to one embodiment of the present invention, achievement prizes are awarded (1) as the only prize for that achievement, (2) in addition to the normal prize for that achievement, (3) as an achievement prize some time after later, for example, at an annual participant conference, or monthly game theme party, etc., (4) at Christmas, (5) on the awardee's birthday, (6) at an opportunistic sports event or concert, etc.

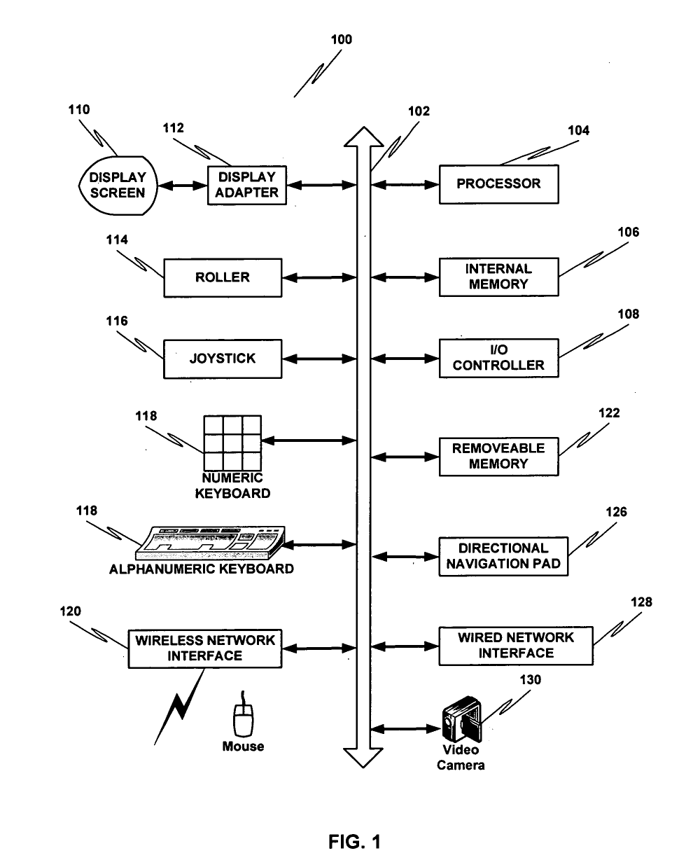

FIG. 1 depicts a block diagram of a computer system 100 suitable for implementing aspects of the present invention. As shown in FIG. 1, computer system 100 comprises a bus 102 which interconnects major subsystems such as a central processor 104, a system memory 106 (typically RAM), an input/output (I/O) controller 108, an external device such as a display screen 110 via display adapter 112, a roller 114, a joystick 116, a keyboard 118, a fixed disk drive 120, a floppy disk drive 122 operative to receive a floppy disk 124, and a CD-ROM player 126 operative to receive a CD-ROM 128. Many other devices can be connected, such as a wireless network interface 132. Wireless network interface 132 may provide a direct connection to a remote server via a wireless link or to the Internet via a POP (point of presence). Alternatively, a network interface adapter 134 may be used to interface to a local or wide area network using any network interface system known to those skilled in the art (e.g., Ethernet, xDSL, AppleTalk™).

Many other devices or subsystems (not shown) may be connected in a similar manner. Also, it is not necessary for all of the devices shown in FIG. 1 to be present to practice the present invention, as discussed below. Furthermore, the devices and subsystems may be interconnected in different ways from that shown in FIG. 1. The operation of a computer system such as that shown in FIG. 1 is readily known in the art and is not discussed in detail in this application, so as not to overcomplicate the present discussion. Code to implement the present invention may be operably disposed in system memory 106 or stored on storage media such as fixed disk 120, floppy disk 124 or CD-ROM 128.

Turning now to FIG. 2, a block diagram that illustrates an interactive picture system in accordance with one embodiment of the present invention is presented. As shown in FIG. 2, an interactive picture system server comprises at least one of each of a processor 222, storage 220 and user interface 218 to one or more of client devices 224 to 250, and communicatively coupled via connection means 214 optionally to one or more of 200 third party systems optionally of types including, for example, Telco 212, SMS/MMS aggregator 210, switch 208, photo site 206, portal 204, payment system 202, and etc, or any combination thereof. User interface 218 may be independent or one and the same with any capable client device or type of device, for example, mobile phone 226, PDA 228, PDA-Phone 238, laptop 244, desktop 242, pocket device 240, or any other, or any combination thereof client devices 224 through 250, and in any two or more in any combination thereof, may network together communicatively coupled via the same connection means 214 or other connection means to communicate together among themselves in any combination thereof. Any one or more of the client devices may communicate with the interactive picture server 216 via one or more of third party systems 200. Also an interactive picture server 216 may communicate with any one or more of third party systems via communication means 214.

According to one embodiment of the present invention, any one or more of client devices 224 through 250 are used by one or more clients to perform interactive picture transactions with interactive picture server 216. By way of example, any one or more, optionally, of third party systems 200, may be used to support client interactive picture transactions. According to one embodiment of the present invention, interactive picture transactions may be in service of, any one or more of interactive picture games or interactive picture services and any combination thereof. [0086] According to one embodiment of the present invention, any one or more of third party systems 432 may be used to support participant interactive picture transactions. Interactive picture transactions may be in service of any one or more of interactive picture games or interactive picture services or combination thereof. An interactive picture system as illustrated in FIG. 2 may comprise the realization, in full or in part, of interactive picture games or services or any combination thereof, as oriented to affinity games, brand games, open market games, dedicated games, education games, community games, other games, general services, security services, other services, or any combination thereof. An interactive picture system as illustrated in FIG. 2 may realize organizational models oriented for profit, non-profit, non-profit fund raising, community, government, education, business development, marketing, social development, other, or any combination thereof.

According to one embodiment of the present invention, the functionality of a client device 252 and a server 216 is combined into a single device (not shown in FIG. 2). According to another embodiment of the present invention, the functionality of user interface 218 is performed by client device 252.

In the context of the present invention, the connections, networks, or both, of the interactive picture system, servers, client devices, their components, and third party systems, may be one or more connections, networks, shared, or unshared in any configurations among the components. Thus also in the context of the present invention, the components, hardware, software, or both, may be physically and/or logically co-located or distributed or incorporated among each other or incorporated in other systems in any configuration.

Turning now to FIG. 3, a block diagram that illustrates an interactive picture system in accordance with one embodiment of the present invention is presented. As shown in FIG. 3, an interactive picture system comprises a Logical Data Store 326 interacting with one or more engines 340 and 330 which, if plural, may exchange system messages and information 332 among themselves. Engines 330 and 340 may optionally exchange system messages and information with any one or more other engines 330 and 340. Engines 330 and 340 realize, for example, optionally and without limitation, any one or more of functions 334. One or more engines 340 exchange system messages and information 336, optionally with one or more third party systems 324, and exchange system messages and information with one or more client devices 338. As shown by reference numeral 310, engines 340 and 330 are optionally accessible through one or more Web Services 312, one or more SDK(s) (Software Development Kit), one or more API(s) (Application Programmer Interface), or any combination thereof.

Still referring to FIG. 3, one or more engines 330 and 340 also exchange system messages and information 320 with one or more user interfaces 308. The one or more user interfaces 308 may be independent or integrated with one or more client devices 338. The one or more client devices 338 may network together communicatively coupled via the same connection means or other connection means to communicate among themselves. Any one or more of the client devices may communicate with the interactive picture engines 340 and 330 via one or more of optional third party systems 324 and 304. Also, one or more of interactive picture engines 240 and 330 may communicate with any one or more of third party systems 324 or 304.

According to one embodiment of the present invention, the functionality of two or more of user interface 300, third party system 324, client device 338, engine 330, engine 340 are combined into a single device (not shown in FIG. 3).

Turning now to FIG. 4, a block diagram that illustrates an open market interactive picture games and services publishing system in accordance with one embodiment of the present invention is presented. As shown in FIG. 4, an interactive picture system comprises a logical data store 426 interacting with one or more engines, for example, one or more author engines 422, one or more sponsor engines 424, one or more audience engines 428, one or more third party system engines 430, one or more client engines 420, one or more commentator engines 416, one or more operator engines 414, one or more developer engines 400, one or more other engines, or any combination thereof. According to one embodiment of the present invention, one or more engines exchange system messages with one or more other engines.

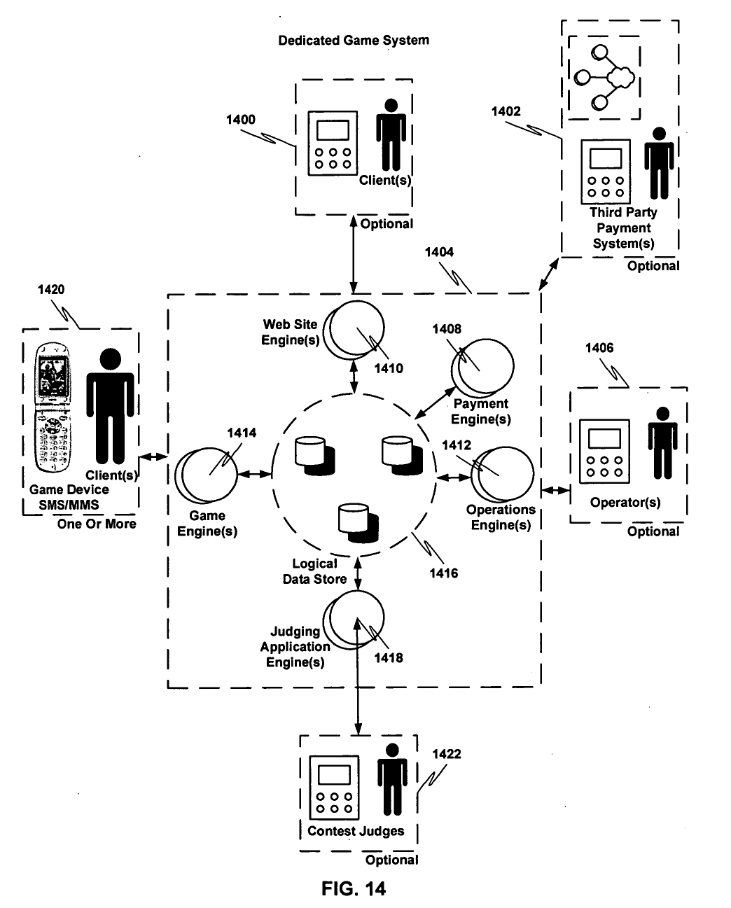

According to one embodiment of the present invention, an interactive picture system illustrates a logical composition of system components, that may be organized in other ways. By way of example, an interactive picture system may be organized as one engine, such as reference numeral 340 of FIG. 3. As another example, an interactive picture system may be organized as one or more engines realized in a particular implementation form, such as shown in FIG. 6. As another example, an interactive picture system may be organized as engines realized in a particular implementation form, such as shown in FIG. 4. According to one embodiment of the present invention, an interactive picture system is realized in a particular implementation form as shown in FIG. 14. Those of ordinary skill in the art will understand other implementation forms would be suitable as well.

According to one embodiment of the present invention, one or more engines, for example, one or more author engines 422, one or more sponsor engines 424, one or more audience engines 428, one or more third party system engines 430, one or more client engines 420, one or more commentator engines 416, one or more operator engines 414, one or more developer engines 400, one or more other engines, or any combination thereof, exchange messages with one or more of their respective corresponding entities, i.e. one or more authors 410, one or more sponsors 434, one or more audience 436, one or more third party systems 432, one or more clients 418, one or more commentators 404, one or more operators 402, one or more developers 400, one or more judges (reference numeral 670 of FIG. 6), one or more other entities, or any combination thereof.

According to one embodiment of the present invention, one or more participants, including for example and without limitation, one or more authors 410, one or more sponsors 434, one or more audience 436, one or more third party systems 432, one or more clients 418, one or more commentators 404, one or more operators 402, one or more developers 400, one or more Judges (reference numeral 670 of FIG. 6), one or more other participants, or any combination thereof, may participate through one or more interactive picture system portals, one or more web sites, one or more web services, one or more applications, one or more UI-capable client devices, other systems, or any combination thereof.

According to one embodiment of the present invention, that function may be provided by one or more engines, such as engines 330 of FIG. 3, client engines 420, third party system engines 430, audience engines 428, portal engines 666 of FIG. 6, other engines, or any combination thereof.

According to one embodiment of the present invention, interactive picture system 406 exchanges messages with one or more user interfaces, including for example, user interfaces for one or more authors 410, one or more sponsors 434, one or more audience 436, one or more third party systems 432, one or more clients 418, one or more commentators 404, one or more operators 402, one or more developers 400, one or more judges (reference numeral 670 FIG. 6), other participants, or any combination thereof. Such user interfaces may be independent or one and the same with any one or more client devices (reference numeral 252 of FIG. 2). One or more client devices (reference numeral 252 of FIG. 2) may optionally network together communicatively coupled via the same connection means or other connection means to communicate together among themselves in any combination thereof. Any one or more of the client devices may optionally communicate with the interactive picture system 406 via one or more of optional third party systems 432, or any combination thereof.

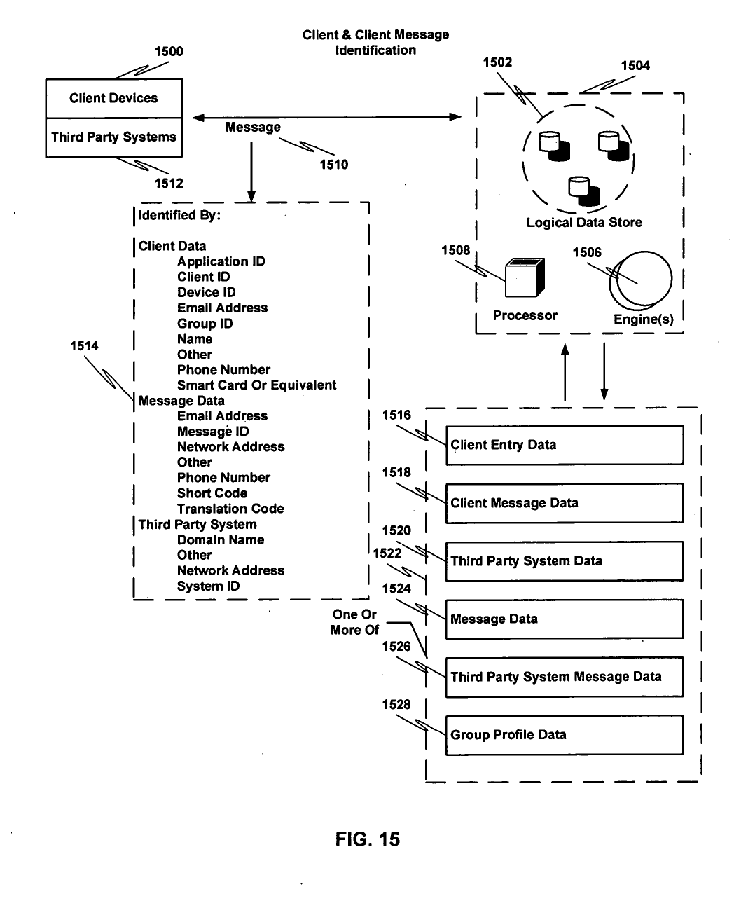

According to one embodiment of the present invention, the interactive picture system 406 may realize (1) interactive picture systems according to FIG. 2, (2) interactive picture systems of the architecture, function(s), or any combination thereof, of FIG. 3, (3) open market interactive picture systems of FIG. 4, (4) the open market interactive function flow of FIG. 5, (5) the open market interactive picture system of FIG. 6, (6) the open market interactive picture example transactions, functions, or interactions, or any combination thereof, of FIGS. 7 and 8, (7) the game/service patterns of FIGS. 9 and 10, (8) a dedicated embodiment function flow of FIGS. 11 and 12, (9) a dedicated judging function of FIG. 13, (10) a dedicated interactive picture game system of FIG. 14, (11) interactive picture supporting functions of FIG. 15, (12) interactive picture supportive functions of FIG. 19, (13) interactive game models of FIG. 16, (14) interactive picture game categories of FIG. 17, (15) interactive picture services of FIG. 18, (16) other interactive picture functions, or (17) any combination thereof.

According to one embodiment of the present invention, interactive picture system 406 exchanges messages, or transactions, or any combination thereof, with one or more third party systems 432, which third party systems, may optionally include, telecommunications systems, mobile phone carrier systems, the Internet, inter-networks, intranets, extranets, corporate systems, the World Wide Web, Web Services Sites, picture-oriented web sites, photo service web sites, photo sharing web sites, archive sites, multi-media web sites, peer-to-peer networks, VoIP (Voice over IP) services, chat services, email services, SMS aggregators, MMS aggregators, SMS/MMS aggregators, SMS services, MMS services, SMS/MMS services, brokers, switches, aggregators, portals, personal sites, TiVo devices, TiVo services, payment systems, applications, networks, servers, search engines, auction services, entertainment web sites, product sales web sites, community web sites, product sales web sites, affinity group web sites, fund raising web sites, blog services, blog web sites, security services, cryptographic services, news services, stock photo web sites, video web sites, medical services, real estate web sites, travel web sites, adult entertainment web sites, dating sites, nature related web sites, art related web sites, merchandise sales web sites, music web sites, band web sites, concert promotion web sites, ticket services, sports oriented web sites, education web sites, government services web portals, graphic arts sites, photo print services, photo sales sites, video sales sites, video processing services, photo album sites, cartoon sites, animation sites, television series sites, film promotion sites, video shorts sites, video short series sites, gift sites, other systems, or any combination thereof.

According to one embodiment of the present invention, any one or more of third party systems 432 may be used to support participant interactive picture transactions. Interactive picture transactions may be in service of any one or more of interactive picture games or interactive picture services or combination thereof. An open market interactive picture system as illustrated in FIG. 4 may comprise the realization, in full or in part, of interactive picture games or services or any combination thereof, as oriented to affinity games, brand games, open market games, dedicated games, education games, community games, other games, general services, security services, other services, or any combination thereof. An open market interactive picture system FIG. 4 may realize organizational models oriented for profit, non-profit, non-profit find raising, community, government, education, business development, marketing, social development, other, or any combination thereof.

According to one embodiment of the present invention, the connections, networks, systems, components, or any combination thereof of the interactive picture system 406, client devices 418, and third party systems 432, other components, or any combinations thereof, may be one or more connections, networks, systems, components, or any combination thereof, shared or not shared, in any configurations known to those versed in the art. Thus the components, hardware and/or software, may be physically and/or logically co-located or distributed or incorporated among each other or incorporated in other systems in any configuration.

According to one embodiment of the present invention, the functionality of two or more of commentator 404, client 418, third party system 432, audience 436, sponsor 434, author 410, developer 400, and operator 402 are combined into a single device (not shown in FIG. 4). According to another embodiment of the present invention, the functionality of two or more of commentator engine 416, operator engine 414, developer engine 412, author engine 422, sponsor engine 424, audience engine 428, third party system engine 430, and client engine 420 are combined into a single device (not shown in FIG. 4).

According to one embodiment of the present invention, one or more third party systems 432 comprise one or more open market interactive picture systems 406, one or more interactive picture systems as illustrated in FIG. 3, one or more interactive picture systems as illustrated in FIG. 2, one or more dedicated interactive picture game systems as illustrated in FIG. 14, one or more other interactive picture systems, or any combination thereof.

Turning now to FIG. 5, a high-level flow diagram that illustrates a method for an open market interactive picture games and services publishing portal business in accordance with one embodiment of the present invention is presented.

Turning now to FIG. 5, a high-level flow diagram that illustrates a method for an open market interactive picture games and services publishing portal business, in accordance with one embodiment of the present invention, is presented. At 500, one or more engines are configured by one or more developers. For example, one or more author engines (reference numeral 410 of FIG. 4) may be configured to support authoring of games, services, or both, using one or more optional game or service patterns like those shown in FIG. 9, other game/service patterns, or both. Alternatively or in addition thereto, the one or more engines may be configured to create games of one or more of the game modes illustrated in FIG. 16, or other games modes, or any combination thereof. Alternatively or additionally thereto, the one or more engines may be configured to create games of one or more of the game categories illustrated in FIG. 17, or other game categories, or any combination thereof. Alternatively or additionally thereto, the one or more engines may be configured for creating one or more interactive picture services of the kinds illustrated in FIG. 18, or other kinds, or any combination thereof, including any combination of both games and services.

According to one embodiment of the present invention, one or more sponsor engines (reference numeral 424 of FIG. 4) are configured to support sponsoring of one or more authored interactive picture games or services or any combination thereof. According to another embodiment of the present invention, one or more audience engines (reference numeral 428 of FIG. 4) are configured to enable one or more audience participation in sponsored interactive picture games or services, or other services, or any combination thereof. According to another embodiment of the present invention, one or more third party systems engines (reference numeral 430 of FIG. 4) are configured to enable sponsored interactive picture games or services, or other services, or any combination thereof. According to another embodiment of the present invention, one or more client engines (reference numeral 420 of FIG. 4) are configured to enable one or more clients (reference numeral 418 of FIG. 4) to participate in sponsored interactive picture games or services, or other services, of any combination thereof. According to another embodiment of the present invention, one or more commentators engines (reference numeral 416 of FIG. 4) are configured to enable one or more commentators (reference numeral 404 of FIG. 4) to participate with respect to one or more transactions, author participation, authored games, authored services, sponsor participation, sponsored games, sponsored services, audience participation, client participation, commentator participation, other participants, third party system(s) participation, other system(s), or any combination thereof. According to another embodiment of the present invention, one or more operator engines (reference numeral 414 of FIG. 4), or one or more developer engines (reference numeral 412 of FIG. 4), or any combination thereof, are configured to enable operation (reference numeral 402 of FIG. 4) and development (reference numeral 400 of FIG. 4) for one or more interactive picture systems. According to another embodiment of the present invention, one or more other engines, are configured to enable one or more other transaction(s).

Referring again to FIG. 5, according to one embodiment of the present invention, one or more developers realize enough engines configured 500 to enable at least a first authoring 502 sufficient to enable a first sponsoring 506 sufficient to enable client participation 508 in at least one interactive picture game or service or any combination thereof. According to one embodiment of the present invention, after the configuring by one or more developers to enable at least one client's participation 504, further occurrences of any one or more of the steps of 504 may occur in any order, and optional further steps, including for example, any one or more of steps 510 may occur in any order with respect to any of the steps of 504.

According to one embodiment of the present invention, the flow of interactive picture steps of FIG. 5 are in service of any one or more of interactive picture games or interactive picture services or any combination thereof. An open market interactive picture function flow may comprise the realization of interactive picture games or services or any combination thereof, as oriented to affinity games, brand games, open market games, dedicated games, education games, community games, other games, general services, security services, other services, or any combination thereof. An open market interactive picture function flow as illustrated by FIG. 5 may, for example, realize one or more organizational models oriented for profit, non-profit, non-profit fund raising, community, government, education, business development, marketing, social development, other, or any combination thereof.

Turning now to FIG. 6, a high-level system flow diagram that illustrates a distributed engine architecture method for an open market interactive picture games and services publishing portal business in accordance with one embodiment of the present invention is presented. As shown in FIG. 6, the arrow elements of the diagram indicate potential direction of message flow, and the square black ‘tabs’ with arrows facing them indicate message communication to the one square black ‘tab’ with arrow facing away 638. Also, the directional lines are not numbered, as the diagram intends a system graph which enables the realization of many specific orders of flow, in a well formed way. According to one embodiment of the present invention, the system illustrated by FIG. 6 is a sub-system of one or more interactive picture systems, such as FIG. 3, FIG. 4, FIG. 14, or any combination thereof.

According to embodiments of the present invention, FIG. 6 illustrates potential flows of realization of the functions of FIGS. 7 and 8. According to one embodiment of the present invention, FIG. 6 illustrates a system realization of the functions of FIGS. 11 and 12. According to another embodiment of the present invention, FIG. 6 illustrates a system realization of the functions of FIG. 13. According to another embodiment of the present invention, FIG. 6 illustrates an application of the functions of FIG. 15. According to another embodiment of the present invention, FIG. 6 illustrates an application of the functions of FIG. 19. According to another embodiment of the present invention, FIG. 6 illustrates a realization of the games of FIG. 17, the game modes of FIG. 16, and any combination thereof. According to another embodiment of the present invention, FIG. 6 illustrates a system data flow realization for the dedicated interactive picture game system of FIG. 14, for the games of FIG. 17, in the game modes of FIG. 16, and any combination thereof.

According to one embodiment of the present invention, FIG. 6 illustrates a potential subsystem of flows of realization of an open market interactive picture system illustrated in FIG. 4. In this embodiment, audience participants of the interactive picture system portal become members through the one or more audience engines 612 to the one or more member engines, where they may also arrange payment for optional transactions privileges through the one or more payment engines 636 and the one or more third party payment system engines 606, and optionally register their membership status as authors, sponsors, commentators, clients, other, or any combination thereof.

According to one embodiment of the present invention, one or more authors may use the one or more author engines 610 to create one or more new games or one or more new services, or any combination thereof, first validating their transactions and membership using the one or more validation engines 620 and then creating the new one or more games or services in the logical data store 654, via the one or more archive engines 630.

According to one embodiment of the present invention, one or more sponsors may use the one or more sponsor engines 608 to sponsor one or more games, one or more services, or any combination thereof, first validating their transactions and membership using the one or more validation engines 620 and then sponsoring one or more games, one or more services, or any combination thereof, from the logical data store 654, via the one or more archive engines 630.

According to one embodiment of the present invention, all critical, and optionally, other events are logged by the one or more audit log engines 644 in one or more audit trails of the logical data store 654 via the one or more archive engines 630.

According to one embodiment of the present invention, a brand-oriented sponsor may configure promotions associated with a game via the one or more promotions engines 646 and stored in the logical data store 654 via the one or more archive engines 630.

According to one embodiment of the present invention, one or more commentators may use the one or more commentator engines 674 to create one or more reviews of one or more games, one or more services, or any combination thereof, first validating their transactions and membership using the one or more validation engines 620 and then storing them in the logical data store 654 via the one or more archive engines 630 so they are available on the portal through the portal one or more engines 666 to audience participants.

According to one embodiment of the present invention, one or more audience participants may read the commentator reviews, browse other commentator materials and site materials and choose to buy, through the one or more payment engines 636, client membership through the one or more membership engines 642.

According to one embodiment of the present invention, one or more clients may participate in one or more games, one or more services, or any combination thereof, through the one or more client engines 676, first validating their membership, or creating an ad-hoc membership, or any combination of both, through the one or more member engines 642, receiving one or more promotions messages from the one or more promotions engines 646, and during their participation in one or more games, services, or any combination thereof, sending one or more picture transactions where the picture message is validated to various criteria by the one or more validation engines 620, filtered as to objectionable content by the one or more filter engines 622, checked as duplicate by the one or more duplicates engines 626, indexed and archived in the logical data store 654 by the one or more archive engines 630, one or more analysis engines 664, or any combination thereof, and optionally notified of receipt by the one or more notification engines 678, with picture transactions logged in an audit trail of the logical data store 630 by the one or more audit log engines 644 via the one or more archive engines 630.

According to one embodiment of the present invention, the one or more auto awards engines continuously inspect new pictures in the logical data store 654 via the one or more archive engines 630 and upon finding a picture meeting auto-award criteria in the logical data store 654, award the one or more clients, sending an award notice to them and transacting with the one or more audit log engines 644 to log the event in an audit trail of the logical data store 654 via the one or more archive engines 630.

According to one embodiment of the present invention, the one or more member engines by monitoring of awards in the logical data store 654, via the one or more archive engines 630, or by transaction from one or more other engines, or any combination thereof, discovers an unpaid payable award, auto-award, or any combination thereof, and transacts with the one or more payouts engines to make that payout transaction to the client, through a third party payment membership indicated in the client membership information, via client registered one or more third party payment systems engines 606.

According to one embodiment of the present invention, for problems or opportunities that may occur during their transactions, a participant may be sent an alert message as transacted with the one or more alerts engines 656 by any other one or more engines, and the one or more alerts engines transact with the one or more audit trail engines 644 so that the alert event is logged in an audit trail of the logical data store 654 via the one or more archive engines 630.

According to one embodiment of the present invention, the one or more analysis engines inspect the contents of picture entries to games from the logical data store 654 via the one or more archive engines 652 and transact with the one or more categorization engines to pre-process, categorize, auto-judge, other, or any combination the above, for picture entries to games according to game information from the logical data store 654 via the one or more archive engines 652, and recording the processed status to the logical data store 654 via the one or more archive engines 652.

According to one embodiment of the present invention, the one or more archive engines 630 and 652 may be the same one or more engines or different one or more engines, or any combination thereof.

According to one embodiment of the present invention, judging 670, according to any of the methods of judging illustrated in FIG. 13, occurs as transacted by the one or more judging engines for unjudged judgeable picture entries from the logical data store 654 via the one or more archive engines 652, with updated status recorded to the logical data store 654 via the one or more archive engines 652, and any awards transacted with the awards engines 660 for one or more awards messages to be sent to the participant, prize delivery, prize payout, logging of the events in an audit log of the logical data store 654 via the one or more archive engines 630 by transaction to the one or more audit log engines 644, or any combination thereof.

According to one embodiment of the present invention, the interactive picture system flow of FIG. 6 is in service of any one or more of interactive picture games or interactive picture services and any combination thereof. An open market interactive picture system flow may comprise the realization, of interactive picture games or services or any combination thereof, as oriented to affinity games, brand games, open market games, dedicated games, education games, community games, other games, general services, security services, other services, or any combination thereof. According to another embodiment of the present invention, an interactive picture system flow FIG. 6 realizes one or more organizational models oriented for profit, non-profit, non-profit fund raising, community, government, education, business development, marketing, social development, other, or any combination thereof.

According to one embodiment of the present invention, the functionality of two or more of the engines shown in FIG. 6 are combined into a single device (not shown in FIG. 6).

FIGS. 7 and 8 are schema diagrams that illustrate example transactions for kinds of participants of an interactive picture system, in accordance with one embodiment of the present invention. FIG. 8 is a continuation of FIG. 7. According to one embodiment of the present invention, FIGS. 7 and 8 illustrate enabling features for transactions of all participant types of an open market interactive picture system of FIG. 4.

FIGS. 9 and 10 show a block diagram that illustrates examples of a method for game/service pattern concepts in accordance with one embodiment of the present invention is presented. FIG. 10 is a continuation of FIG. 9. According to one embodiment of the present invention, the patterns of FIG. 9 and FIG. 10 may be implemented in one or more interactive picture engines by developers using tools known to experts versed in the art. Such tools include, by way of example, OWL editors, rules engines, OWL engines, rules, other engines, processing components of hardware, software, or any combination thereof, component references, user interfaces, object oriented software components, MOJO, etc.

According to one embodiment of the present invention, the patterns of FIGS. 9 and 10 are used by one or more developers (reference numeral 400 of FIG. 4) to realize one or more author engines (reference numeral 422 of FIG. 4), one or more engines of FIG. 6, other engines, or any combination thereof, to realize one or more games of, for example, of the type illustrated in FIG. 17, on an open market interactive picture system illustrated in FIG. 4.

According to another embodiment of the present invention, the patterns of FIGS. 9 and 10 are used by one or more developers (reference numeral 400 of FIG. 4) to realize one or more engines of FIG. 6, other engines, or any combination thereof, to realize one or more games of, for example, of the type illustrated in FIG. 17, on a dedicated interactive picture game system illustrated in FIG. 14.

FIGS. 11 and 12 show a flow diagram that illustrates a method for interactive picture prize-contest game in accordance with one embodiment of the present invention is presented. FIG. 12 is a continuation of FIG. 11. The processes illustrated in FIGS. 11 and 12 may be implemented in hardware, software, firmware, or a combination thereof. In FIGS. 11 and 12, a picture contest per-player function flow is shown, where the functions of processes for multiple players may happen in any relationship to each other. FIG. 11 also illustrates in one embodiment of the present invention, a game cycle begins with sending a promotion of the game to client 1100, receiving play message from client 1102, optionally performing an opt-in transaction 1110 with client by sending an opt-in invitation to client 1404 and receiving opt-in reply “yes” message 1106 from client, optionally sending a welcome message 1108 to the client, then in any order performing the functions, including, receiving contest entry pictures 1112, and optionally the functions 1124, in any order, including receiving text messages from client 1114, sending notification messages to the client 1116, sending text messages to the client 118, sending award messages to the client 1120, sending other messages to the client 1122, or any combination thereof. According to one embodiment of the present invention, a game cycle continues for a client, while optionally performing the following functions 1200 in any order with messages received: archiving entries, archiving messages, award points, award prizes, categorize entries, check for duplicate entries, filter objectionable entries, judge entries, send notification messages, send promotion messages, send text messages, validate entries, other, or any combination thereof, and which may be processed in any order with functions of 1126; then at the end of the game cycle 1202 optionally perform the functions 1206, including, to judge any unjudged entries, award entries and send prize notifications to the client, or any combination thereof, including with functions 1210 in any order with functions 1206, archive messages, reject entries, send notification messages, send promotion messages, send text messages, other, or any combination thereof.

Turning now to FIG. 13, a flow diagram that illustrates a method for interactive picture prize-contest game judging in accordance with one embodiment of the present invention is presented. The processes illustrated in FIG. 13 may be implemented in hardware, software, firmware, or a combination thereof. As shown in FIG. 13, receiving contest entry pictures and processing them with one or more functions 1300 may be performed in any order, including, for example, optional functions 1302 such as analyzing picture contents, archiving process results, auto-awarding prizes, categorizing pictures for judging, checking for picture as a duplicate entry, auto filtering objectionable entries, partially pre-processing judging of pictures, validating entries, along with any required functions, in any order, archive 1304 and judge entries 1306, or any combination thereof. According to one embodiment of the present invention, each contest entry picture is presented 1314 to one or more judging functions, in any order, including, for example, judging by a human judge 1316 using a user interface 1332, judging by an animal 1318 with one or more animals 1330, judgment reported by one or more sensors 1326 aided by, optionally, one or more systems 1328, or judging by another event 1320, where the ‘judgment’ of the other event is reported by one or more sensors 1322 aided optionally by one or more systems 1324, or any combination thereof, and where the results of the judging is reported 1312 and then processed 1310 by one or more optional functions 1308 in any order, including, for example, send text messages to clients, send promotions to clients, categorize judged entry picture, award judged prizes to clients, send notices to clients, archive process results, other, or any combination thereof.

In accordance with one embodiment of the present invention, in using of a user interface 1332 for judging by human(s), the user interface may be capable of realizing optional functions, including in any order, categorizing entry pictures by methods such as, by way of example, ranking by rank of 1 to 10, ranking by triage, tracking by judged and unjudged, marking for awards, marking for prizes, organizing pictures in portfolios, organizing judging process by projects, organizing portfolios by games, indicating to send notices, indicating to send text messages, indicating to send award notifications, indicating to award prizes, indicating to categorize, categorizing by schemas for type, reviewing judgment events, reviewing judging results, managing judging activities, consulting with one or more other judges, voting among judges, organizing judging by steps for multiple judges, other, or any combination thereof.

According to one embodiment of the present invention, one or more sensors 1326 may be used to report the judging of entry pictures by one or more animals 1330. The one or mores animals may, for example, include, a dog, a bird, a dolphin, an octopus, a fish, an elephant, a monkey, a cow, a horse, a cat, a mouse, others, or any combination thereof. The picture is presented to the animal by methods such as print, user interface, projection, other, or any combination thereof; and where the one or more sensors detect certain behaviors of the animals interpreted as judging indications 1312.

According to another embodiment of the present invention, one or more sensors 1322 are used to report the judging of entry pictures by one or more other events 1320. The other event may, for example, include, weather changes, cloud movement, radiation events, clock events, entertainment events, television events, radio events, rolling of dice, spinning of roulette wheel, movement of tree branches in the wind, stock market events, throwing of the bones, chaos events, public events, draw of cards, draw of tarot cards, opening of fortune cookies, lottery events, coincidence of multiple events, music events, language events, sound events, thunder events, lightning events, earthquake events, wave events, tsunami events, sports events, volcano events, casino events, political events, random events, promotional events, statistical events, others, or any combination thereof. According to another embodiment of the present invention, a picture is selected by an event by one or more methods, including, scheduled for the event, calculated by the event, pointed to by the event, other, or any combination thereof. According to another embodiment of the present invention, the one or more sensors detect certain behaviors of the other events interpreted, by timing, calculation, pointing, other, or any combination thereof, as judging indications 1312.

Turning now to FIG. 14, a block diagram that illustrates an interactive picture application system comprising an interactive picture contest system in accordance with one embodiment of the present invention is presented. As shown in FIG. 14, a subset of the open market interactive picture system illustrated in FIG. 4 can be realized for dedication to interactive picture contest games, where there is not support for open market authoring of new games, and there is also not open market sponsoring of games, but where the operators 1406 of the dedicated interactive picture contest game system arrange it to be set it up for the games it provides to one or more clients 1420. In more detail, contest games may need judges 1422. And to decide the winners of the contest games, these Judges may, for example, perform their judging according to the method of FIG. 13.

According to another embodiment of the present invention, one or more clients 1420 may participate via one or more client devices. Alternatively or in addition thereto, one or more clients 1400 may participate in the system through a web site portal, where they, or participants, or any combination thereof, also participate in the role of audience 436.

According to another embodiment of the present invention, one or more clients pay for their participation via one or more third party payment systems 1402.

According to one embodiment of the present invention, the dedicated interactive picture contest game system 1404 may be in service of one or more interactive picture contest games. A dedicated interactive picture contest game function flow may comprise the realization of one or more interactive picture contest games, as oriented to affinity games, brand games, dedicated games, education games, community games, or any combination thereof. According to one embodiment of the present invention, a dedicated interactive picture contest function flow as illustrated in FIGS. 11 and 12, realizes one or more organizational models oriented for profit, non-profit fund raising, community, education, business development, marketing, social development, other, or any combination thereof.

According to one embodiment of the present invention, the functionality of two or more of client 1400, third party payment system 1402, operator 1406, contest judges 1422, and game device 1420 are combined into a single device (not shown in FIG. 14). According to another embodiment of the present invention, the functionality of two or more of game engine 1414, web site engine 1410, payment engine 1408, operations engine 1412, and judging application engine 1418 are combined into a single device (not shown in FIG. 14).

According to one embodiment of the present invention, the dedicated interactive picture contest game system 1404 realizes a simple interactive picture photo contest game, where clients 1420 learn about a game through promotional materials or word of mouth or any combination thereof, including game instructions regarding how to submit a photo entry. Clients may send one or more photo entries from a client device 1420 to an interactive picture dedicated game system 1404 by means of MMS or email or any combination thereof, to one or more email addresses, phone numbers, short codes, or any combination thereof. According to one embodiment of the present invention, the photo entries are validated for format, return email address, phone number or any combination thereof, and archived in a logical data store 1416. One or more judges 1422 use a judging application engine 1418 to browse and categorize the archived photo entries. The one or more judges select the winners of one or more games at the completion of the game cycle, and send notification of prize award to the winning clients, e.g. by SMS text messaging. SMS notification messages may be sent by the game engine 1414, by a third party system engine through a third party SMS broker or aggregator or telecommunications carrier, by hand with an SMS-capable mobile phone, or by any combination thereof. Prizes may be awarded at certain time periods in the game cycle. According to one embodiment of the present invention, photo entries that are not suited for contests are collected with contest entries for use in an event portfolio. The event portfolio can be exchanged with an event or concert promoter for use in a promotional album, web site, DVD, CD, or any combination thereof. According to one embodiment of the present invention, there is an address for sending photo entries only for use in the album portfolio. Prizes can be concert-related items. The photo prize contest may be operated for a concert event, or other event, or no event, or any combination thereof. Fees are collected for the MMS messages to the interactive picture system 1404. One or more clients have ad-hoc memberships, or all clients have ad-hoc memberships. According to one embodiment of the present invention, the interactive picture system 1404 is located remotely from the judging application engines 1418, which are optionally located in one or more laptops and connected by network to the interactive picture system 1404. According to one embodiment of the present invention, the photo contest is operated to promote a brand and subsequent participation of clients. According to one embodiment of the present invention, the photo contest is operated to test new games.

Turning now to FIG. 15, a block diagram and schema that illustrates a method for client and message identification for an interactive picture system in accordance with one embodiment of the present invention is presented. As shown in FIG. 15, messages 1510 received by an interactive picture system 1504 from, optionally, one or more client devices, one or more third party systems 1512, or any combination thereof, may be identified by one or more engines 1506 using any combination of information including any one or more data structures 1522 from a logical data store 1502, and any one or more data elements 1514 from the message 1510, to realize participant transactions, including with, optionally, features of participant membership, ad-hoc membership, or any combination thereof.

Turning now to FIG. 16, a schema diagram that illustrates example game modes for an interactive picture game system in accordance with one embodiment of the present invention is presented. As shown in FIG. 16, one or more interactive picture system engines may be configured to support games of various modes, including competitive games 1600, non-competitive games 1606, or any combination thereof. According to one embodiment of the present invention, one or more interactive picture system engines may be configured to support games of various modes of competitive games, including games for prizes 1602, games without prizes 1604, or any combination thereof.

According to one embodiment of the present invention, interactive picture game systems may be set up for game participation in various modes designed to fit business criteria. By way of example, such business criteria comprises any one or more of the participants, stockholders, market situation, economics, business finances, technology, participant motivations, participant capabilities, legal requirements, other stakeholders, other criteria, or any combination thereof.

Turning now to FIG. 17, a schema diagram that illustrates example game categories for an interactive picture game system in accordance with one embodiment of the present invention is presented. As shown in FIG. 17, one or more interactive picture game system engines may be configured for games organized according to various categories, to various patterns such as those illustrated in FIGS. 9 and 10, and to any combination thereof.

According to one embodiment of the present invention, there is a rich ontology of game category relationships that can be used to design game products by configuring interactive picture game systems for game participation in various modes designed to fit business criteria, such as, by way of example, criteria of any one or more of the participants, stockholders, market situation, economics, business finances, technology, participant motivations, participant capabilities, legal requirements, purses, other stakeholders, other criteria, or any combination thereof.

According to one embodiment of the present invention, business functions of an interactive picture game system, such as, by way of example, game product design, marketing, sales, promotions, prizes, prize types, prize sizes, prize frequencies, games design, payment fees, merchandise, frequent participation points, portfolio functions, group functions, contest design, prize roll-forward, membership, ad-hoc membership, game cycle, third party distribution, remote configuration, commentator participation, projects, teams, achievement prizes, social values, other, or any combination thereof, may be tuned to optimize the chances of achieving the goals of the business.

Turning now to FIG. 18, a schema diagram that illustrates example services for an interactive picture service system in accordance with embodiments of the present invention is presented. As shown in FIG. 18, one or more interactive picture service system engines may be configured for one or more services meeting various patterns, such as, by way of example, the patterns illustrated in FIGS. 9 and 10.

According to one embodiment of the present invention, there is a rich variety of interactive picture service products for service participation designed to fit business criteria. Such business criteria may comprise, by way of example, criteria of any one or more of the participants, stockholders, market situation, economics, business finances, technology, participant motivations, participant capabilities, legal requirements, purses, other stakeholders, other criteria, or any combination thereof.

According to one embodiment of the present invention, business functions of an interactive picture service system, such as, by way of example, marketing, sales, promotions, prizes, service design, payment fees, merchandise, frequent participation points, portfolio functions, group functions, participation roll-forward, membership, ad-hoc membership, service cycle, third party distribution, remote configuration, commentator participation, projects, teams, achievement prizes, social values, other, or any combination thereof, may be tuned to optimize the chances of achieving the goals of the business.

Turning now to FIG. 19, a schema diagram that illustrates example virtual organization types for an interactive picture game/service system in accordance with one embodiment of the present invention is presented. As shown in FIG. 19 illustrates, functional features of virtual organization, including one or more virtual groups 1900, one or more virtual collections 1902, or any combination thereof, realize the ability for an interactive picture business to design interactive picture systems functions that better fit the participants. By way of example, in regard to their multiple valued relationships, such functional features include criteria of: family groups, extended family groups, work groups, geographical groups, age groups, educational groups, work teams, game teams, other social groups, other social teams, clubs, memberships, neighborhoods, communities, ad-hoc situations, ad-hoc relationships, projects, events in their lives, economics, other criteria, or any combination thereof.

According to one embodiment of the present invention, there is a rich variety of interactive picture service virtual organization functions for designing participation to fit business criteria. By way of example, such business criteria may include criteria of any one or more of the participants, stockholders, market situation, economics, business finances, technology, participant motivations, participant capabilities, legal requirements, purses, other stakeholders, other criteria, or any combination thereof.

According to one embodiment of the present invention, business functions of an interactive picture system, such as, by way of example service product design, marketing, sales, promotions, prizes, service design, payment fees, merchandise, frequent participation points, virtual organization functions, participation roll-forward, membership, ad-hoc membership, service cycle, third party distribution, remote configuration, commentator participation, projects, teams, achievement prizes, social values, other, or any combination thereof, may be tuned to optimize the chances of achieving the goals of the business.

According to one embodiment of the present invention, one or more picture products are made available for sale, distribution, other use, or any combination thereof. According to one embodiment of the present invention, the Logical Data Store (reference numeral 654 of FIG. 6), contains one or more pictures managed for availability as picture products, which are available to participants, third party systems, or any combination thereof, including through an interactive picture portal. According to another embodiment of the present invention, one or more participants may select picture products or customize a portfolio picture product for their purchase, where, for example, the audience engine(s) give a participant the choice of forms to receive their picture product, customized picture product portfolio, or any combination thereof. Such forms include, by way of example, picture files, prints, print albums, bound albums, CDs, DVDs, screensaver pictures, mobile phone wallpaper, calendars, mugs, t-shirts, other print merchandise, other picture forms, or any combination thereof.

According to one embodiment of the present invention, integration with other services, including through third party systems (reference numeral 200 of FIG. 2) is accomplished. According to one embodiment of the present invention, one or more participants configure the integration of other services in their profile information in a logical data store (reference numeral 654 of FIG. 6), which is managed by one or more member engines (reference numeral 642 of FIG. 6). According to another embodiment of the present invention, one or more other services integrated with interactive pictures comprise chat services, VoIP services, location services, GPS services, peer-to-peer services, dating services, community services (for example Craig's List), other SMS products, TiVo, entertainment services, archive services, telecommunications services, other security services, other photo services, other video services, sweepstakes, raffles, other publications, music services, print services, merchandise services, medical services, government services, military services, real estate services, real estate services, travel services, casinos, news services, blogs, third party services, other services, or any combination thereof. According to one embodiment of the present invention, interactive pictures may integrate with other services via third party distribution.

While embodiments of the present invention have been described with respect to interactive pictures, embodiments of the present invention may also include integrated security functions, including identification, authentication, verification, encryption, message authentication, transaction authentication, digital rights management, access controls, passwords, biometrics, smart cards, challenge and response protocols, crypto-protocols, crypto-systems, system security methods, portal security methods, security pocket servers, federated identity, trusted systems, fraud detection, fraud prevention, penetration detection, penetration prevention, security functions of third party systems, digital watermarking, high integrity protocols, high integrity transactions, secure uploads, secure downloads, checksums, content validation, public key methods, secret key methods, key management, zero knowledge methods, other methods known to those skilled in the art, or any combination thereof.

While embodiments of the present invention have been described with respect to interactive pictures, embodiments of the present invention may also include application of interactive pictures for baby oriented games, services, or any combination thereof. By way of example, baby contest games may be sponsored and integrated with other publications or events, so that, for example, winning baby pictures are published, including, without limit, in a magazine, a magazine cover, in posters, on portals, in films, other media, or any combination thereof. Also by way of example, baby games may be integrated with other functions, including prizes, promotions, travel, products, services, events, functions of third party systems, other functions, or any combination thereof. Additionally, the integrated functions may be organized based at least in part on baby-related themes with the associated games.

While embodiments of the present invention have been described with respect to interactive pictures, embodiments of the present invention may also include features where participants configure a list of preferred prizes, prize types, or any combination thereof, in their member profiles through an interactive picture portal, and where the prizes or prize types available for configuration, or any combination thereof, are from pre-configured prizes, prize types, or any combination thereof.

While embodiments of the present invention have been described with respect to interactive pictures, embodiments of the present invention may also include participation by upload, where for example pictures are uploaded to a portal, interactive picture portal, third party system, or any combination thereof. By way of example, pictures may be selected for play from one or more uploaded locations, where uploaded locations may include, for example, portals, personal web sites, photo web sites, telecommunications web sites, TiVo, archive web sites, corporate portals, third party systems, other locations, or any combination thereof.

While embodiments of the present invention have been described with respect to interactive pictures, embodiments of the present invention may also include remote configuration, where data stored locally in a device or system is managed by one or more remote configuration engines. By way of example, remote configuration engines may be accessed by a participant through a web browser, when the participant configuration transactions are transacted with the remote configuration engines, then the remote configuration engines can transact the changes to the locally stored data. Also by way of example, a participant may download an interactive picture engine into their mobile phone, where there was no local user interface to the local engine configuration data, and they can transact management changes through an interactive picture portal to their profile via a remote configuration function, which can then transact the synchronizing changes to the local engine configuration data in their mobile phone over a network.

While embodiments of the present invention have been described with respect to interactive pictures, embodiments of the present invention may also include where judging may be accomplished by voting by other participants, including, for example, audience, clients, or any combination thereof.

While embodiments of the present invention have been described with respect to interactive pictures, embodiments of the present invention may also include games of business orientation, including affinity games, brand games, community games, dedicated games, education games, open market games, or any combination thereof. By way of example, affinity games may be games sponsored in conjunction with an affinity group, where an agreed portion of the payments collected for the game are provided to the affinity group, and where the affinity group optionally undertakes promotions of the affinity group games where they are a sponsor participant. By way of example, sponsors may be of various types, including, affinity group sponsors, brand sponsors, community sponsors, education sponsors, other sponsors, or any combination thereof. By way of example, brand games may be games sponsored in conjunction with a brand of service, product, or any combination thereof, where the one or more sponsored games, prizes, promotions, or any combination thereof, are designed to a common theme for promoting that brand. By way of example, overlay type games, points, frequent participation points, promotions, or any combination thereof, may be coordinated to provide additional games, promotions, or any combination thereof for interactive picture participants. By way of example, interactive picture games, services, or any combination thereof may be of dedication orientation, where the embodied interactive picture system does not include open market functions, and is dedicated to the games, services, or any combination thereof with which it is configured.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A method for interactive pictures, the method comprising:
configuring one or more engines to support one or more picture games or one or more picture services of an interactive picture game or service system;
authoring one or more picture games or one or more picture services for support by said one or more engines;
sponsoring at least one of said one or more picture games or one or more picture services; and
allowing one or more client having a client device to play said one or more picture games or to use said one or more picture services, said one or more picture games and said one or more picture services comprising the submission of one or more pictures via said client device.

2. The method of claim 1 wherein interactive pictures are integrated with other services.

3. The method of claim 1 wherein one or more picture products are customized and purchased through a portal.

4. The method of claim 1 wherein at least one of said sponsoring and said authoring are realized by said configuring.

5. The method of claim 1 wherein said configuring further comprises configuring said one or more engines to support said authoring of one or more picture games or said one or more picture services.

6. The method of claim 5 wherein said configuring further comprises using one or more ontology tools to support said authoring of one or more picture games or said one or more picture services.

7. The method of claim 1 wherein said configuring further comprises configuring said one or more engines using one or more runtime deployment tools.

8. The method of claim 7 wherein said one or more runtime deployment tools comprises one or more Mascot-compliant tools.

9. The method of claim 7 wherein said one or more runtime deployment tools comprises one or more MOJO tools.

10. The method of claim 1, further comprising providing one or more customized picture collections as a product.

11. The method of claim 10, wherein said customized picture collections comprise one or more of an album, a screen save, a wallpaper, a CD, a DVD, and a calendar.

12. The method of claim 5 wherein said configuring further comprises using one or more game or service patterns to support said authoring of said one or more picture games or said one or more picture services.

13. The method of claim 5 wherein said configuring further comprises configuring said one or more engines to create one or more competitive picture games.

14. The method of claim 13 wherein said one or more competitive picture games comprise picture games for which prizes are awarded and games for which non-prizes are awarded.

15. The method of claim 14 wherein said prizes comprise one or more of cash, a certificate, one or more points, one or more privileges, one or more products, and one or more services.

16. The method of claim 14 wherein said prizes comprise one or more of a certificate and notoriety.

17. The method of claim 14, further comprising deferring the delivery or transfer of prize value to a participant in order to carry that value forward to apply to a future prize delivery.

18. The method of claim 14 wherein said prize comprises one or more products reserved for awards as prizes limited to participants who meet predetermined achievement criteria.

19. The method of claim 5 wherein said one or more picture games comprise one or more non-competitive games comprising one or more of achievement games, art games, collaboration games, discovery games, fun games, play games, and relationship games.

20. The method of claim 5 wherein said configuring further comprises configuring said one or more engines to create one or more business orientation games, game packages, collaboration games, overlay games, brand orientation games, affinity games, educational games, or community orientation games.

21. The method of claim 5 wherein said configuring further comprises configuring said one or more engines to create one or more security services.

22. The method of claim 21 wherein said one or more security services comprises one or more of an agent monitor, a block watch, a boat monitor, one or more checkpoints, a child monitor, a crime report, an event monitor, a family monitor, a house monitor, a lost or stolen vehicle monitor, or a site monitor.

23. The method of claim 5 wherein said one or more picture services comprises one or more of an animal watch service, an aquarium service, a bird watch service, a dating game service, an educational service, an event invitations service, an event witness service, a fish watch service, a good citizen service, a lost object service, a lost pet service, a mapping service, a news service, a “show me” service, a story development service, a story presentation service, a stud finder service, a test service, a “want to buy” service, a “want to rent” service, a “want to sell service”, a weather service, or a “what is this” service.

24. The method of claim 1 wherein said configuring further comprises configuring one or more sponsoring engines to support said sponsoring of said one or more picture games or picture services.

25. The method of claim 1 wherein said configuring further comprises configuring one or more audience engines to support audience participation in sponsored interactive picture games or picture services.

26. The method of claim 1 wherein said configuring further comprises configuring one or more third party systems engines to enable sponsored interactive picture games or picture services.

27. The method of claim 1 wherein said configuring further comprises configuring one or more client engines to enable one or more clients to participate in sponsored interactive picture games or picture services.

28. The method of claim 1 wherein said configuring further comprises configuring one or more commentator engines to enable one or more commentators to participate with respect to one or more transactions, author participation, sponsored games, sponsored services, audience participation, client participation, commentator participation, or third party participation.

29. The method of claim 1 wherein said client device comprises one or more of a PDA, an iPod, a video camera, a laptop computer, a server, a desktop computer, a digital camera, a mobile phone, pocket server, a PDA-Phone, a pocket device, or a smart vehicle.

30. A method for client and message identification, comprising:
receiving one or more messages in an interactive picture system; and
identifying said one or more messages based at least in part on:
one or more data elements from said one or more messages; and
one or more data structures from a logical data store within said interactive picture system.

31. The method of claim 30 wherein said one or more data elements comprise one or more of client data, message data, and third party system data.

32. The method of claim 30 wherein said one or more data structures comprise one or more of client entry data, client message data, third party system data, message data, third party system message data, and group profile data.

33. A method for determining membership, comprising:
receiving in an interactive picture game or service system, a game or service request from an unrecognized game or service client; and
creating an immediate membership for said unrecognized game or service client based at least in part on one or more identities available in one or more messages of a service message exchange between said interactive picture game or service system and said unrecognized game or service client.

34. The method of claim 33 wherein said identities comprise one or more of a phone number, a device ID, an email address, or a network address.

35. The method of claim 33 wherein said membership expires upon the completion of an initiating game or service cycle.

36. The method of claim 33 wherein said membership expires upon the completion of a period of time of no activity.

37. The method of claim 33 wherein said membership is for use during a concert game.

38. A method for interactive pictures, the method comprising:
configuring one or more engines to support one or more picture games of an interactive picture game system;
authoring said one or more picture games for support by said one or more engines;
sponsoring at least one of said one or more picture games; and
allowing one or more clients having a client device to play said one or more picture games, said one or more picture games comprising the submission of one or more pictures via said client device.

39. The method of claim 38 wherein at least one of said sponsoring and said authoring are realized by said configuring.

40. The method of claim 38, further comprising accepting payment from said one or more clients for participation in said one or more picture games, via one or more third party payment systems.

41. The method of claim 38 wherein said one or more games comprise one or more of affinity games, brand games, dedicated games, education games, or community games.

42. The method of claim 38, further comprising accepting one or more photo entries from said one or more client devices of said interactive picture game system.

43. The method of claim 42, further comprising accepting one or more photo entries from said one or more client devices of said interactive picture game system via multimedia messaging (MMS) or email.

44. The method of claim 42 wherein said one or more clients send one or more photo entries from said one or more client devices to one or more of an address, a phone number, or a short code.

45. The method of claim 38, further comprising validating said photo entries for one or more of format, return email address, or phone number.

46. The method of claim 38, further comprising notifying winning clients.

47. The method of claim 38, further comprising notifying winning clients via one or more SMS notification messages.

48. The method of claim 38, further comprising collecting photo entries that are submitted but are ill-suited for contests.

49. The method of claim 38 wherein one or more of said clients have ad-hoc memberships.

50. The method of claim 2, further comprising configuring integration of integrated picture participation with one or more other services.

51. The method of claim 50, further comprising customizing said integration through a portal.

52. The method of claim 2 wherein said one or more other services comprise one or more of chat services, VoIP services, location services, GPS services, peer-to-peer services, dating services, community services (for example Craig's List), other SMS products, TiVo, entertainment services, archive services, telecommunications services, other security services, other photo services, other video services, sweepstakes, raffles, other publications, music services, print services, merchandise services, medical service, government services, military services, real estate services, travel services, casinos, news services, blogs, and third party services.

53. The method of claim 50 wherein said interactive pictures are integrated with one or more services by a third party.
